(19) United States
(12) Patent Application Publication
(10) Pub. No.: US 2024/0363037 A1
(43) Pub. Date: Oct. 31, 2024

(54) LIGHTING ASSEMBLY INCLUDING AT LEAST ONE TRANSMISSIVE 3D-PRINTED BODY

(71) Applicant: Trent N. Butcher, Sandy, UT (US)

(72) Inventor: Trent N. Butcher, Sandy, UT (US)

(21) Appl. No.: 18/415,014

(22) Filed: Jan. 17, 2024

Related U.S. Application Data
(63) Continuation-in-part of application No. 18/309,510, filed on Apr. 28, 2023.

(51) Int. Cl. G09F 13/04; B60D 1/60; B60Q 1/50; F21V 11/00; F21Y 113/10; F21Y 115/10; G09F 21/04

(52) U.S. Cl. CPC G09F 13/044; B60D 1/605; B60Q 1/503; F21V 11/00; G09F 21/048; F21Y 2113/10; F21Y 2115/10

(57) ABSTRACT

In some embodiments a lighting assembly may include at least one light-emitting device attached to at least one body. For example, some embodiments of the present invention generally relate to an assembly including at least one light-emitting device attached to a body. However, embodiments of the present invention may also relate to an assembly comprising at least one 3D-printed article attached to at least one non-3D-printed element, such as, for example, a structural element. In such an embodiment, at least one light-emitting device may be attached to the at least one 3D-printed article and/or the at least one structural element. In some embodiments, a lighting assembly may be attached to a vehicle, a house, or another structure/system.

### CROSS-REFERENCE TO RELATED APPLICATION

This application is a continuation-in-part of U.S. patent application Ser. No. 18/309,510, filed Apr. 28, 2023, which is incorporated herein by reference in its entirety, including but not limited to those portions that specifically appear hereinafter.

### BACKGROUND

Assemblies including at least one lighted device are numerous and varied. For example, decorative illuminated trailer hitch covers may limit water, dirt, and other debris from accumulating in the vehicle trailer hitch receiver when it is not in use. Furthermore, the normally unattractive trailer hitch receiver can be covered with a customized, illuminated graphic or sign.

The use of lighted modular trailer hitch receiver covering systems, and methods of use is known in the prior art. For example, U.S. Pat. No. 6,053,627 to Vo et al. discloses a lighted modular trailer hitch receiver covering systems and methods of use. U.S. Pat. No. 5,979,094 to Brafford, Jr. discloses a protective trailer hitch lighted sign that protects the trailer hitch from damage from the elements. Similarly, U.S. Pat. No. 4,800,471 to Lippert discloses a brake light attachment that converts a trailer hitch receiving socket into a third brake light. In addition, U.S. Pat. No. 6,302,567 to Gamble, Sr. discloses an attachable vehicle warning light that can be elevated. Furthermore, U.S. Pat. No. 6,012,828 to Pearce et al. discloses a device for attaching a light to a trailer hitch frame via tie wraps. Finally, U.S. Pat. No. Des. 413,291 to Corns, Jr. discloses a Sports helmet outfitted automotive hitch cover that provides a hitch cover which is not illuminated.

Therefore, a need exists for a new and improved, illuminated assembly that can be used in a customized manner.

### SUMMARY

The invention relates to a lighting assembly including at least one light-emitting device attached to at least one body including at least one groove. For example, some embodiments of the present invention generally relate to an assembly including at least one light-emitting device attached to a body wherein the light-emitting device is weatherproof and/or waterproof. However, embodiments of the present invention also relate to providing an assembly comprising at least one body which is relatively easily manufacturable. In some embodiments, an assembly may comprise at least one 3D-printed article attached to at least one non-3D-printed element, such as, for example, a structural element. In such an embodiment, at least one light-emitting device may be attached to the at least one 3D-printed article and/or the at least one structural element. Optionally, the at least one body may be configured to reduce the time required for forming or manufacturing such body (e.g., machining or 3D printing).

In some embodiments, the invention relates to an automotive accessory assembly including at least one light-emitting device and at least one body. Such an automotive accessory may be attachable (and detachable) from an automobile. In one embodiment, a trailer hitch assembly may comprise a body (e.g., a 3D-printed article) attached to a structural element, wherein at least one light-emitting device is attached to the body. In one embodiment, such at least one light-emitting device may be an elongated light-emitting device positioned at least partially within a recess defined by the body. Accordingly, in one embodiment, the body may include at least one recess sized and configured for the at least one light-emitting device. In some embodiments, the light-emitting device may comprise a flexible, elongated LED light-emitting strip.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

FIG. 1 shows a perspective view of one embodiment of a body;

FIG. 2A shows another perspective view of one embodiment of a body;

FIG. 2B shows a perspective view of one embodiment of a body;

FIG. 3 shows a partial cross-sectional view of one embodiment of a 3D-printed body during 3D printing;

FIG. 4A shows a perspective view of one embodiment of a structural element according to the present invention;

FIG. 4B shows a perspective view of a further embodiment of a structural element according to the present invention;

FIG. 4C shows a perspective view of a further embodiment of a structural element according to the present invention;

FIG. 5A shows a perspective view of one embodiment of an assembly comprising a structural element and a body according to the present invention;

FIG. 5B shows a perspective view of one embodiment of an assembly comprising a structural element and a body according to the present invention;

FIG. 6A shows a perspective view of one embodiment of an assembly comprising a structural element and a body according to the present invention;

FIG. 6B shows a perspective view of one embodiment of an assembly comprising a structural element and a body according to the present invention;

FIG. 7A shows a perspective view and a schematic cross-sectional view of one embodiment of an elongated light-emitting device according to the present invention;

FIG. 7B shows a perspective view of one embodiment of an elongated light-emitting device according to the present invention;

FIG. 7C shows a perspective view of one embodiment of an elongated light-emitting device according to the present invention;

FIGS. 8A-1, 8A-2, 8B-1, 8B-2, 8C-1, 8C-2, 8D-1, 8D-2, 8E-1, 8E-2, 8F-1, 8F-2, and 8F-2 show cross-sectional schematic views of embodiments of the elongated light-emitting device shown in FIG. 7A;

FIG. 9A shows a perspective view of one embodiment of a lighting assembly including a body and an elongated light-emitting device according to the present invention;

FIG. 9B shows a perspective view of one embodiment of an elongated light-emitting device including electrical conductors operably attached thereto;

FIG. 9C shows a perspective view of one embodiment of an elongated light-emitting device including a solderless connector for operably attaching thereto;

FIG. 9D shows a schematic, exploded view of on embodiment of an elongated light-emitting element;

FIG. 9E shows a schematic, partial view of an elongated light-emitting element wherein one end of the elongated light-emitting element overlaps with a distal end of the elongated light-emitting element;

FIG. 9F shows a partial view of a body including a groove with an elongated light-emitting element positioned within such groove, wherein one end of the elongated light-emitting element overlaps with a distal end of the elongated light-emitting element;

FIG. 9G shows a perspective view of the lighting assembly shown in FIG. 9A including an electrical plug;

FIG. 9H shows a perspective view of the lighting assembly shown in FIG. 9G including a cover element;

FIG. 9I shows a cross-sectional view (taken along A-A) of the lighting assembly including a body and an elongated light-emitting device shown in FIG. 9A;

FIG. 9J shows an enlarged cross-sectional view of the lighting assembly including a body and an elongated light-emitting device shown in FIG. 9F;

FIG. 10A shows a perspective view of one embodiment of an assembly comprising a structural element and a body according to the present invention;

FIG. 10B shows a perspective view of one embodiment of an assembly comprising a structural element and a body as shown in FIG. 10A;

FIG. 10C shows a perspective view of one embodiment of a lighting assembly including a body and an elongated light-emitting device according to the present invention;

FIG. 11 shows a schematic, perspective view of a lighting assembly including a body and an elongated light-emitting device according to the present invention and a partial perspective view of a vehicle to which the lighting assembly may be attached; and

FIG. 12 shows a schematic block diagram of a system 300 including at least one lighting assembly;

FIGS. 13A and 13B show respective perspective view of one embodiment of a lighting assembly comprising a transmissive 3D-printed body;

FIG. 13C shows an enlarged cross-sectional view of the lighting assembly shown in FIGS. 13A and 13B;

FIG. 14A shows a perspective view of one embodiment of a panel lighting device of a known type comprising a plurality of LEDs operably attached thereto;

FIG. 14B shows a perspective view of one embodiment of a panel lighting device of a known type comprising a plurality of LEDs operably attached thereto;

FIG. 14C shows a perspective view of one embodiment of a panel lighting device of a known type comprising at least one COB LED;

FIG. 14D shows a perspective view of one embodiment of a panel lighting device of a known type comprising at least one COB LED;

FIGS. 15A and 15B show respective perspective view of one embodiment of a lighting assembly comprising a transmissive 3D-printed body;

FIG. 15C shows a perspective view of a transmissive 3D-printed body including mounting features;

FIGS. 16A and 16B show respective perspective view of one embodiment of a lighting assembly comprising a transmissive 3D-printed body;

FIG. 16C shows a perspective view of one embodiment of a lighting assembly comprising a transmissive 3D-printed body and an electrical plug;

FIG. 17A shows a perspective view of a light panel system already known in the art, which comprises light panels;

FIG. 17B shows a view of a light panel system comprising at least one light panel and at least one transmissive 3D-printed body.

### DETAILED DESCRIPTION

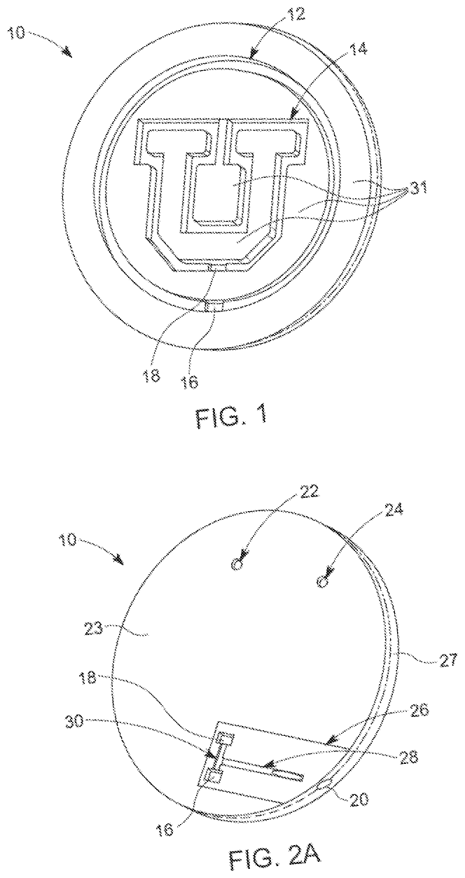

FIG. 1 shows a perspective view of one embodiment of a body 10. Generally, body 10 may include at least one groove (e.g., one groove, more than one groove, a plurality of grooves, etc.). As shown in FIG. 1, body 10 includes groove 12 and second groove 14.

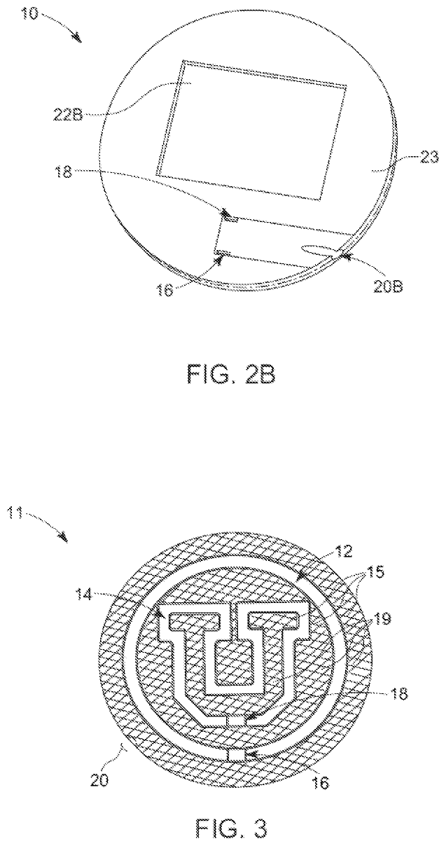

FIGS. 1 and 2A show perspective views of body 10. As shown in FIG. 1, body 10 includes a first groove 12 and a second groove 14. Further, body 10 includes access holes 16 and 18. As shown in FIG. 1, access hole 16 extends from first groove 12 and access hole 18 extends from second groove 14. As shown in FIG. 2A, body 10 includes back surface 23. In some embodiments, optionally, body 10 may include positioning features 22 and 24. Positioning features 22 and 24 may be used to position another component to be attached to body 10 (e.g., the back surface 23 of body 10). Generally, body 10 may include one or more wiring channel extending from one or more access hole. As shown in FIG. 2A, body 10 may include wiring channels 28 and 30, where wiring channel 30 extends between access holes 16 and 18. Further, wiring channel 28 extends between wiring channel 30 and electrical port 20. In one embodiment and as shown in FIG. 2A, electrical port 20 may be defined in the peripheral surface 27 of body 10 and may be angled toward back surface 23, such that electrical port 20 connects to wiring channel 28. This configuration allows for an electrical connector (e.g., a trailer plug or any suitable electrical plug) to supply electricity to at least one light-emitting device (not shown) positioned at least partially in grooves 12 and/or 14. As shown in FIG. 2A and as described in further detail herein, body may comprise a cover recess 26 sized and configured for a cover element (not shown) to be attached thereto (e.g., to cover wiring disposed in wiring channels 28 and 30).

As shown in FIG. 2B, in an alternate embodiment the back surface 23 of body 10 may include a positioning feature 22B formed as a receiving recess formed in the back surface for receiving a counterpart structure on a structural element, as discussed further herein. As depicted, positioning feature 22B may have a rectangular shape, but it will be appreciated that any shape that can be used to provide proper alignment between the components, including polygonal and ovoid shapes may be used. Positioning feature 22B may be used to align and position another component to be attached to body 10 (e.g., the back surface 23 of body 10). In one embodiment and as shown in FIG. 2B, electrical port 20B may be defined in the peripheral surface of body 10 and may be angled toward back surface 23, such that electrical port 20 may be accessible in cover recess 26.

More particularly, in one embodiment, electrical conductors connected to a trailer plug (e.g., 4-way flat, 5-way flat, 4-way round, 6-way round, 7-way round, 7-way blade, 6-way square, or any suitable trailer plug) may pass through electrical port 20 or 20B and one or more of access holes 16, 18 to make electrical connections with at least one light-emitting device positioned at least partially in grooves 12 and/or 14. Various trailer plugs are commercially available from CURT Manufacturing in Eau Claire, Wisconsin.

Generally, body 10 may comprise a polymer, a metal, a metal alloy, and/or any suitable material. For example, body 10 may comprise a polymer (e.g., polyvinyl chloride (PVC)), any metal or metal alloy, brass, stainless steel, aluminum, and/or any other suitable material. The material(s) comprising body 110 is made may be selected to be resistant to corrosion (e.g., resistant to salt water or fresh water corrosion) and/or resistant to damage or degradation from exposure to sunlight.

In some embodiments, body 10 may be injection molded. For example, body 10 may be injection molded and may comprise a suitable thermoplastic. Specifically, PLA (Polylactic Acid) is one common thermoplastic material and another is ABS (Acrylonitrile Butadiene Styrene). Further, in some embodiments, body 10 may comprise one or more of PLA, ABS, EVA, PETG (Polyethylene terephthalate glycol), nylon, acrylonitrile styrene acrylate (ASA), TPE, TPU, PEKK, polypropylene, polycarbonate, carbon fiber reinforced filament material, glass reinforced filament material, filament material including metal particles, and electrically conductive filament material, without limitation. In some embodiments, particularly if body 10 will be outdoors, body 10 may comprise PETG, ASA, or another material, because such material may be relatively resistant to UV rays and/or temperature cycles.

In some embodiments, body 10 may comprise at least one metal, at least one polymer, at least one plastic, at least one rubber, at least one foam (e.g., EVA foam), or at least one metal alloy. In such embodiments, body 10 may be manufactured by any suitable process, including, but not limited to, milling, drilling, turning, electro-discharge machining, laser ablation, grinding, polishing, burnishing, or any other suitable process. In some embodiments, body 10 may comprise stainless steel, aluminum, brass, nickel and/or any other suitable material.

In some embodiments, body 10 may comprise a 3D-printed article. As used herein, “3D printing” (and variants thereof, such as “3D-printed”) means or relates to any technology where a printing device places layer after layer of material until the desired thing (e.g., a three-dimensional object) is formed or printed. 3D printing is also known as additive manufacturing and uses a digital file to create a three-dimensional object. In the 3D printing process, sequential layers of material are selectively positioned and deposited by the ‘3D printer’ until object creation is completed. Each layer is a sliced cross-section of the desired object. With 3D printing, users can produce complicated shapes that would be difficult to form with traditional techniques. The following paragraphs describe various 3D-printing processes.

For example, in powder bed fusion (PBF), thermal energy (e.g., in the form of an electron beam or laser) selectively fuses specific areas of a powder bed to create layers. These layers are built on one another until a part is made. In some embodiments, PBF may include sintering or melting. Once the heat source scans a cross-section or layer, the process is repeated for the next layer. Thus, selectively fused 3D geometry may be formed with the surrounding powder remaining unaffected. Powder bed fusion includes several standard printing methods, such as selective laser sintering (SLS) and direct metal laser sintering (DMLS). SLS is similar to selective laser melting (SLM), electron beam powder bed fusion (EBPBF), and direct metal laser sintering (DMLS). However, these processes are used for creating metal parts and rely on a laser for fusing powder particles, one layer at a time.

VAT photopolymerization includes two methodologies: digital light processing (DLP) and stereolithography (SLA). Both of these processes create components one layer at a time by using a light source to selectively cure liquid material (e.g., usually a resin) stored in a vat. DLP works by ‘flashing’ an image of each complete layer onto the surface of the liquid in the vat. SLA relies on a single-point UV source or laser to cure the liquid. Excess resin is cleaned off the object once printing is completed, after which the object may be exposed to light to improve its strength further.

Binder jetting deposits a layer of powdered material, such as polymer sand, ceramic, or metal, onto a build platform. Then, a print head deposits adhesive drops to bind these particles. The part is hence built layer by layer. Binder jetting has numerous applications, including large-scale ceramic molds, prototypes, and 3D metal printing.

Material jetting is somewhat similar to inkjet printing because one or more print heads are used to deposit layers of liquid material. Each layer is cured before the next layer is produced.

In fused deposition modeling (FDM), a heated nozzle is used to melt and deposit a filament (e.g., comprising at least one thermoplastic) layer by layer. The nozzle increases the temperature of the material, softening and/or melting it before placing it in predetermined areas to cool.

Sheet lamination includes two technologies: ultrasonic additive manufacturing (UAM) and laminated object manufacturing (LOM). UAM has a low energy and temperature requirement and works by joining thin metal sheets using ultrasonic welding. It works with several metals, including stainless steel, titanium, and aluminum. On the other hand, LOM places layers of material and adhesive alternatively to create the final output.

Direct energy deposition uses a laser, electric arc, electron beam, or another form of focused thermal energy to fuse powder or wire feedstock as it is placed. The process creates layers, which are stacked after formation for part creation. Materials including ceramics, polymers, and metals may be used in direct energy deposition.

Accordingly, a “3D-printed article”, as used herein, refers to an object created by additive 3D printing (e.g., an object created by one or more additive 3D printing technique or technology).

3D printing “infill” refers to the internal structure of a 3D-printed part. This internal structure can be produced using many different geometries. Parts manufactured by some traditional manufacturing processes, like injection molding, must be made either completely solid or completely hollow. 3D-printed parts, in contrast, can include a variety of structural patterns that partially fill the space inside the outer surface of the object. The purpose of infill in 3D printing is to reduce both printing time and material by creating a lattice-type structure or cell structure inside of a 3D-printed object. 3D printing fully dense parts is often unnecessary and may be a waste of material. The infill can be strategically placed to provide strength where in-service loads on the part are the highest. The greater the percentage of infill, the higher the density of the part. Often, a variety of infill designs can be selected in the 3D slicing software menu used to prepare an object for printing.

Some examples of infill designs may be found at:

https://www.xometry.com/resources/3d-printing/what-is-infill-in-3d-printing/#:˜text=3D%20printing%20infill%20refers%20to,Many/20different%20infill%20patterns%20exist.

Accordingly, body 10 may comprise any material suitable for 3D Printing, such as any of the materials mentioned herein. For example, FDM may utilize a variety of polymers, such as, for example, one or more thermoplastics. Specifically, PLA (Polylactic Acid) is one a commonly used 3D-printing filament material and another is ABS (Acrylonitrile Butadiene Styrene) filament material. Accordingly, in some embodiments, body 10 may comprise one or more of PLA, ABS, PETG (Polyethylene terephthalate glycol), nylon, acrylonitrile styrene acrylate (ASA), TPE, TPU, PEKK, polypropylene, polycarbonate, carbon fiber reinforced filament material, glass reinforced filament material, filament material including metal particles, and electrically conductive filament material, without limitation. In some embodiments, particularly if body 10 will be outdoors, body 10 may comprise PETG, ASA, or another suitable filament material, because such materials are relatively resistant to UV rays and/or temperature cycles.

Generally, the present invention contemplates that body 10 may comprise infill. In one embodiment, body 10 may comprise infill positioned at least partially between at least one of front surfaces 31 and back surface 23. FIG. 3 shows a cross-sectional view of body 10 during 3D printing. As shown in FIG. 3, infill 15 may comprise a plurality of walls 19 defining a plurality of open cells 17, 21. As shown in FIG. 3, infill 15 may be positioned adjacent to one or more of grooves 12, 14. In one embodiment, at least a portion of body 10 may comprise infill 15 in a volume percentage of between 10% and 90%, between 15% and 80%, between 15% and 25%, between 20% and 50%, between 10% and 15%, between 25% and 75%, between 10% to 20%, or between 30% and 60%.

In addition, a structural element may be attached to the body. Generally, the present invention contemplates that structural element comprises a non-3D-printed article. In some embodiments, structural element may be configured to facilitate attachment of the body to a vehicle, a house, a wall, a window, or any other structure. In utilizing an assembly of a non-3D-printed article attached to a body, such a configuration may reduce manufacturing time, complexity, and/or cost of the resulting assembly. In the case of body 10 comprising a 3D-printed article, such a configuration may also allow for selective customization of the 3D-printed article.

Generally, a structural element may comprise building/manufacturing materials, such as bar stock (e.g., metal or plastic bar stock), square tubing, cylindrical tubing, one or more pipes, one or more suction cups, one or more linear rails or slides (e.g., V-slot linear rail, T-slot linear rail), wood, one or more hooks, one or more clips, one or more dowels, one or more magnets, one or more gears, one or more cogs, one or more chains, one or more shafts, one or more plates, one or more rods, one or more channels, one or more Velcro® fasteners, one or more tongue in groove features, and/or one or more clamps. Any structural element contemplated herein may comprise a polymer (e.g., a plastic and/or rubber), a metal, a metal alloy, and/or any other material. In one embodiment, a fastening element may comprise aluminum, carbon steel, stainless steel, one or more metal, and/or a metal alloy.

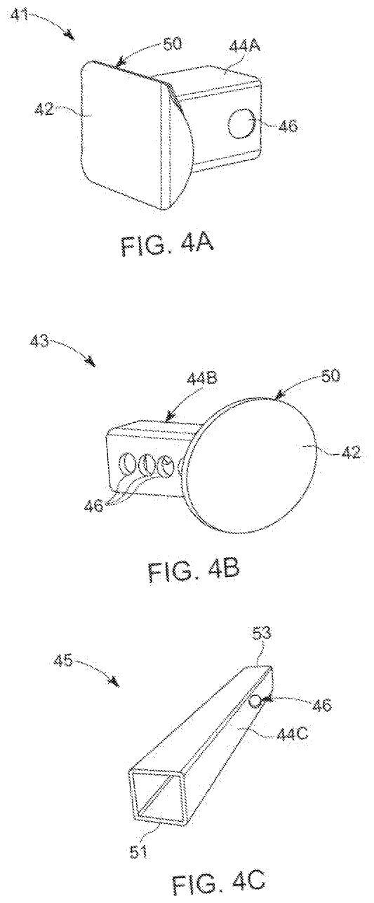

FIGS. 4A and 4B show perspective views of two respective embodiments of structural elements 41, 43. As shown in FIGS. 4A and 4B, structural elements 41, 43 generally comprise a shaft 44 attached to a front cover 50. Shafts 44A and 44B includes one or more pin holes 46A and 46B for mounting into a vehicle hitch receiver. Shafts 44A and 44B may comprise any size suitable for mounting into a vehicle hitch receiver, without limitation. Further, as shown in FIGS. 4A and 4B, front cover 50 may include cover surface 42. In addition, FIG. 4C shows a perspective view of one embodiment of a structural element. As shown in FIG. 4C, structural element 45 may comprise a hollow square tubing 44C of a selected length in which one or more pinholes 46C may be formed. In some embodiments, either end 51, 53 of structural element 45 may be attached to a body. Such a configuration may provide for a relatively simple and cost-effective structural element.

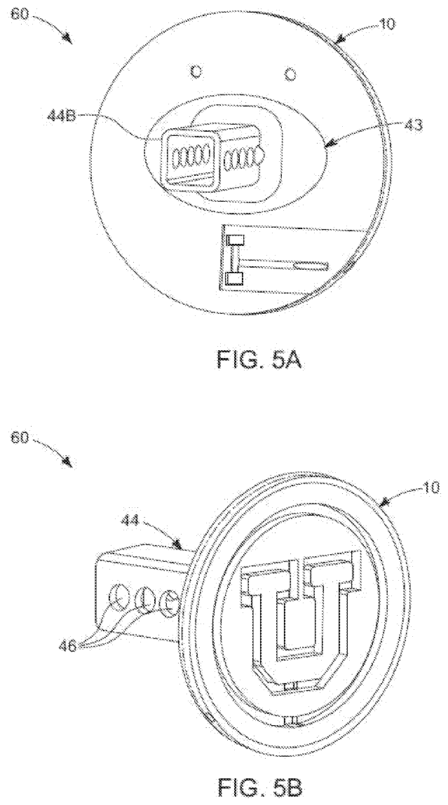

FIGS. 5A and 5B show a lighting assembly 60 comprising a body 10 and a structural element 43. In one embodiment, as shown in FIGS. 5A and 5B, a body and a structural element may be attached to one another. For example, body 10 and front cover 50 may be adhesively bonded (e.g., glued), welded, and/or attached to one another via one or more fastening element. For example, an adhesive may be disposed between at least a portion of a front surface 42 (of either of structural elements 41, 43) and back surface 23 of body 10. Optionally, body 10 and front cover 50 may contact (e.g., forced/positioned against one another, such as by being clamped together or by a weight positioned such that body 10 and front cover 50 are forced against each another) while the adhesive cures. In some embodiments, a polyurethane-based adhesive may be used. For example, at least one Loctite® PL® adhesive, Loctite® PL Premium® adhesive may comprise an adhesive fastening body to the structural element. In some embodiments, a silicone-based adhesive may be used to attach or fasten body to the structural element. For example, in some embodiments, adhesive may comprise 3M™ Marine Adhesive Sealant 5200 (fast cure or standard cure; commercially available from 3M). In some embodiments, a copolymer rubber-based sealant may be used to fasten body to the structural element. For example, in some embodiments, adhesive may comprise LEXEL® elastic sealants (commercially available from SASHCO).

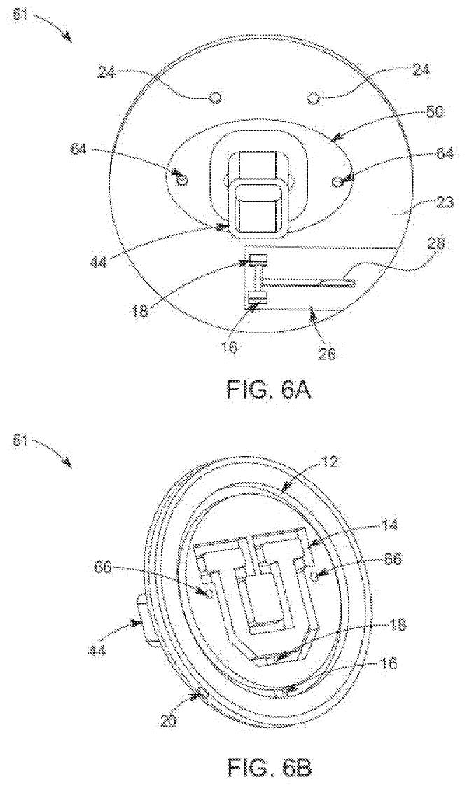

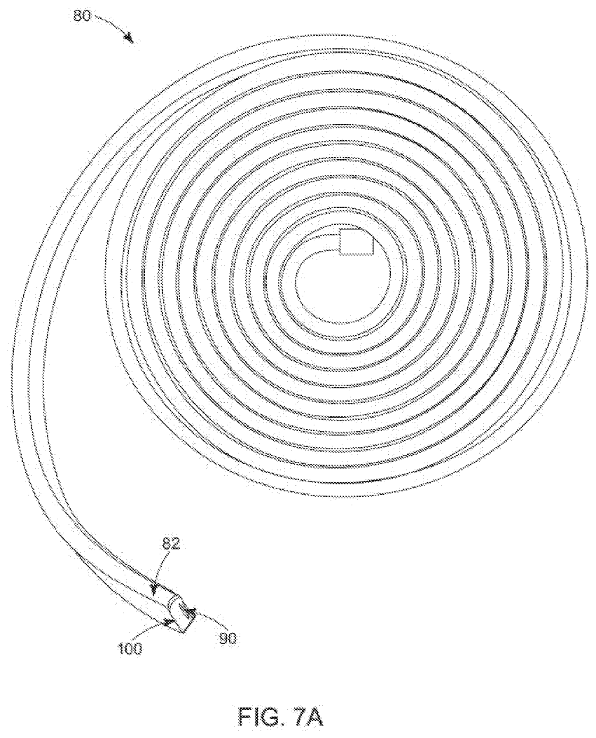

In one embodiment, a body 10 may be attached to a structural element 41/43 by one or more fastening elements (e.g., one or more screw, pin, clip, bolt, and/or rivet, etc.) extending through one or more mounting hole in a structural element (e.g., front cover 50) and corresponding one or more mounting hole in a body. FIGS. 6A and 6B show a lighting assembly 61 including a body 10 and a structural element 43. In further detail, as shown in the embodiment shown in FIGS. 6A and 6B, body 10 may include mounting holes 66 and front plate 50 of structural element 43 may include corresponding mounting holes 64. Further, in one embodiment, mounting holes 66 and mounting holes 64 may be aligned by positioning front plate 50 against back surface 23 of body 10 and one or more fastening element (not shown) may extend through front cover 50 of structural element 41/43. As shown in FIGS. 6A and 6B, two holes 64 may be formed through front cover 50, where a fastening element may be positioned in each hole 64. A fastening element may comprise a pin, a threaded fastener, a rivet, a push-in rivet (e.g., of the type used for automotive applications, such as bumper retainer clips or splash shield clips), automotive retainer clips, or any other suitable fastener or fastening element. A fastening element may comprise a polymer (e.g., a plastic), a metal, a metal alloy, and/or any other material. In one embodiment, a fastening element may comprise aluminum, carbon steel, stainless steel, one or more metal, and/or a metal alloy.

As may be appreciated, in some embodiments, a body may be releasably attached to a structural element. In some embodiments, the at least one fastening element used to attach the body to a structural element may be removable. In other embodiments, one or more magnet (e.g., one or more neodymium magnet) may be press-fit (e.g., into a recess formed by body), adhesively attached, or otherwise attached to body and/or structural element. Further, one or more of body and/or structural element may comprise at least one magnetic material (e.g., a ferrous material, iron, nickel, cobalt, gadolinium, dysprosium, terbium, certain types of steel, neodymium). Optionally, in some embodiments, more than one body may be configured to be attached (i.e., one at a time) and/or removed relative to a structural element. Such a configuration may allow for selective customization of an assembly comprising a body and a structural element.

In a further aspect of the present invention, in some embodiments, a light-emitting device may be attached or coupled to a body and/or a structural element. Such a configuration may provide an appealing appearance when the light-emitting device is energized. In one embodiment, a light-emitting device may include at least one LED (Light Emitting Diode). For example, LED Rope or Wire lighting may be used in any of the embodiments contemplated herein. LED rope may, in one embodiment, comprise flexible transparent or colored PVC tube with a plurality of sub-miniature LED light devices. In another example, a light-emitting device may comprise LED ribbon Lighting (LED FLEX RIBBON STRIP is a is a flexible thin strip incased in a coating). In another example, a light-emitting device may comprise so-called LED NEON-FLEX, which may comprise a flexible body (e.g., a silicone body) surrounding a series of individual LED lights (e.g., an LED lighting strip). Laser-Wire and other lighting strips, ropes, or wires (e.g., sold by Ellumiglow.com, of Portland, Oregon.) may be included in any of the embodiments contemplated herein. LED NEON-FLEX comprises solid-state Light Emitting Diodes (LED's) in series housed by an inner extrusion core, and a UV stable outer jacket, which may further protect the inner core. Such LED NEON-FLEX is available in a vast array of colors.

In some embodiments, a light-emitting device may comprise laser-illuminated fiber optic filaments such as side-light and end-light plastic optical fiber (often called “POF” or “fiber”). In one embodiment, PMMA (acrylic) may be the core material, and fluorinated polymers may be the cladding material. Generally, such polymer optical fibers are designed for flexible and controlled light transfer of light from one point to another and along the sides of the cable/fiber no matter the visible color of the light source. In some instances, a careful mechanical treatment of the fiber surface could produce a side glow line of visible light. Many fiber optic cables are composed of several individual strands of PMMA acrylic fibers (also referred to as plastic fiber optic cable) covered by a clear PVC coating. Further, fiber optic lighting utilizes an illuminator, often referred to as the light engine, light pump, light source or transformer which is affixed to one end of the cable. The illuminator houses the lamp that provides the light for the fiber optic cable. The fiber is connected to the illuminator via a fiber head. One fiber optic embodiment may comprise a multimode, multi-strand, OFNP cable.

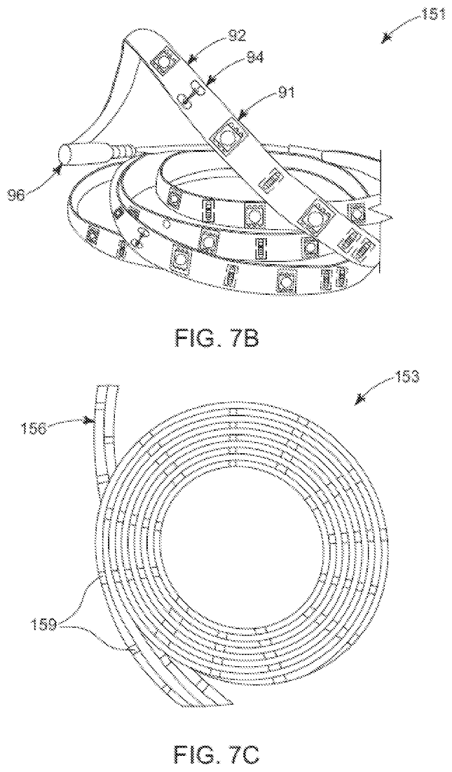

In one embodiment, an assembly according to the present invention may comprise an elongated light-emitting element. For example, as shown in FIG. 7A, an elongated light-emitting element 80 may comprise a light-emitting strip 90 embedded within a flexible body 100. Further, top surface 82 may be configured for transmitting light generated by the light-emitting strip 90 therethrough. In such an embodiment, the other surfaces of flexible body 100 may be configured for limiting or preventing transmission of light generated by the light-emitting strip 90 therethrough. Put another way, elongated light-emitting element 80 may be configured for emitting light preferentially (e.g., in a selected fashion and/or direction, or in relation to the exterior surfaces of light-emitting element 80). In some embodiments, light-emitting strip 90 may comprise diodes such as light-emitting diodes (LEDs) or organic light-emitting diodes (“OLEDs”). Such LEDs may include one or more of a variety of components (e.g., P-type semiconductors, N-type semiconductors semiconductor films, such as Gallium Nitride films, etc.) that emit light (e.g., visible light, infrared light, ultraviolet light, etc.) when a voltage is applied. During use, the light-emitting strip 90 may be energized and thereby emit light.

In some embodiments, light-emitting strip 90 may be configured to operate on a nominal 12-volt direct current (e.g., ˜13.8 direct current voltage) electrical supply. In other embodiments, light-emitting strip 90 may be configured to operate on a direct current voltage exceeding 14 volts. For example, a voltage converter may convert 10-32 volts direct current at its input to a higher voltage (e.g., 14-36 volts, 24-48 volts, or greater than 50 volts) at its output to lighting assembly strip 90. In some embodiments, lighting assembly strip 90 may have a selected power rating (e.g., at least about 10 watts, at least about 15 watts, at least about 20 watts, greater than about 10 watts, between about 5 watts and about 15 watts, or between about 15 watts and about 50 watts. Optionally, a switch (e.g., an electrical switch,) may be operably coupled to a power source (e.g., a 12-volt battery) or incorporated into an electrical driver and may be used to energize lighting assembly strip 90.

Although light-emitting strip 90 is illustrated as having a generally thin or tape-like geometry, light-emitting strip 90 may be any shape or size. For example, any light-emitting strip may exhibit/include one or more selected: shape (e.g., a cylindrical shape, a circular shape, a rectangular shape, and/or any suitable shape, without limitation); size; electrical configuration (e.g., voltage and/or amperage); one or more color (e.g., red, white, blue, green, multiple colors (e.g., RGB, RGBW, any selected one or more color, etc.); power consumption (e.g., at least about 5 watts, at least about 10 watts, at least about 20 watts, at least about 30 watts, at least about 40 watts, at least about 50 watts, greater than about 10 watts, between about 10 watts and about 20 watts, or between about 5 watts and about 15 watts); or light output. In some embodiments, a light-emitting strip may comprise one or more so-called “NEON” LED strip light, an LED rope light, a flexible LED strip or any other suitable light-emitting device, without limitation. Any one or more light-emitting device may be included in any of the embodiments disclosed herein. Light-emitting devices are commercially available from companies including, but not limited to, superbrightleds.com, Honeywell, Amazon.com, and Commercial Electric. In some embodiments, light-emitting device may be waterproof (e.g., rated IP58, IP59, IP60, IP61, IP62, IP63, IP64, IP65, IP66, IP67, IP68, or IP69K), and/or suitable for outdoor use.

In other embodiments, an elongated light-emitting element 80 may comprise a light-emitting strip including a protective coating or cover. For example, FIG. 7B shows a perspective view of a light-emitting strip 151 comprising a repeating pattern of light-emitting areas 91 and electrical connection pads 94. In some embodiments, light-emitting strip 151 may comprise an electrical connector 96, but in other embodiments, electrical connector may be removed (and electrical conductors may be utilized). Further, substantially transparent cover 92 is positioned about the outer surface of the light-emitting strip 151. As is commonly known, light-emitting strips are often configured with a plurality of connection pads which are typically separated by a selected distance. This configuration may provide the ability to cut the light-emitting strip 151 to a desired length, such that at least one of the ends is cut to allow for electrical connection (e.g., solder connection) to each of the connection pads. The same configuration allowing a user to select a length of a light-emitting device may be true for any elongated light-emitting element (e.g., light-emitting element 80) which includes a light-emitting strip. In such a configuration, the body of the elongated light-emitting element may, optionally, be marked (e.g., on at least one outer surface thereof) to indicate a position of the electrical connection pads.

In other embodiments, an elongated light-emitting element 80 may comprise a light-emitting rope including a protective coating or cover. For example, FIG. 7C shows a perspective view of a light-emitting rope 153 comprising a repeating pattern of light-emitting devices 159. In some embodiments, light-emitting rope 153 may comprise an electrical connector (not shown), but in other embodiments, electrical connector may be removed (and electrical conductors may be utilized). Further, substantially transparent cover 156 is positioned about the outer surface of the light-emitting rope 153. As is commonly known, light-emitting ropes may be configured with electrical conductors that extend between light-emitting devices 159 by a selected distance. This configuration may provide the ability to cut the light-emitting rope 153 to a desired length, such that at least one of the ends is cut to allow for electrical connection (e.g., solder connection) to electrical conductor. The same configuration allowing a user to select a length of a light-emitting device may be true for any elongated light-emitting element (e.g., light-emitting element 80) which includes a light-emitting rope 153.

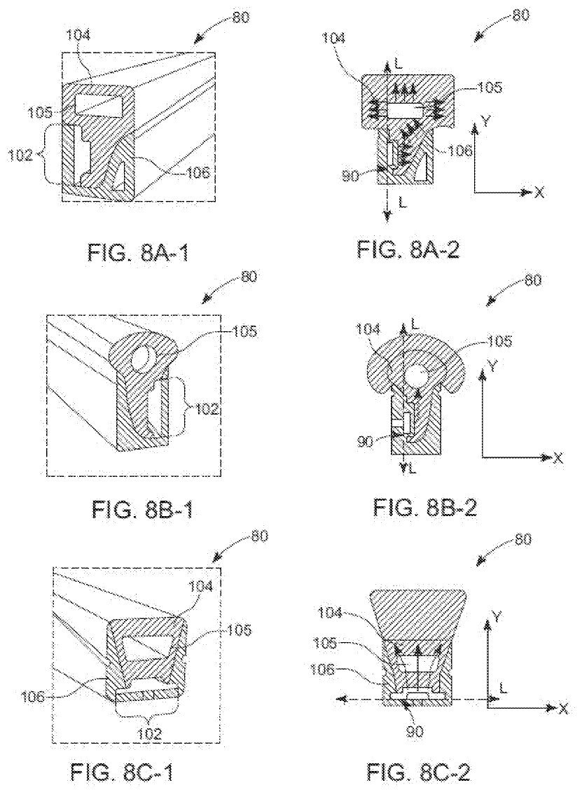

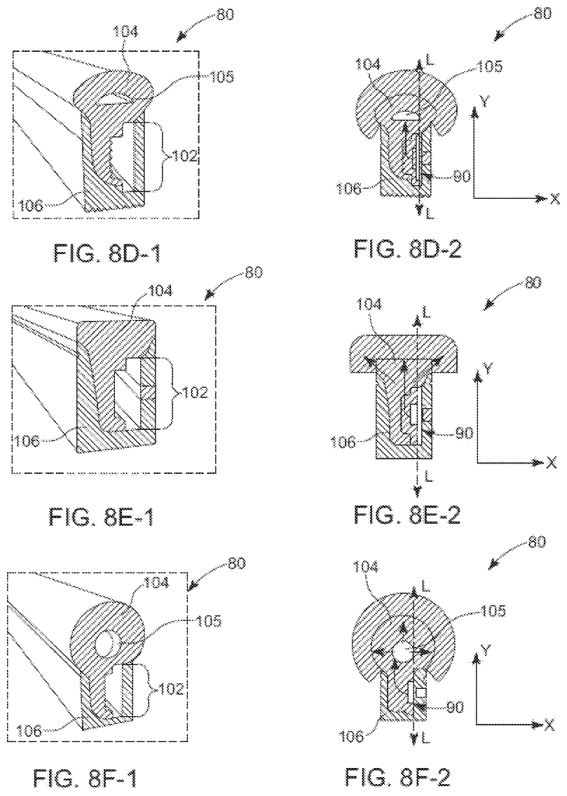

FIGS. 8A-1 to 8F-2 show cross-sectional views of embodiments of body 100 (without a light-emitting device) and cross-sectional views of flexible elongated light-emitting elements 80 comprising a body 100 including a relatively opaque portion 106 and a light-transmissive portion 104 (e.g., relatively translucent, transparent, and/or transmissive) during use. As shown in FIGS. 8A-1 to 8F-2, a flexible light strip 90 (e.g., a flexible LED light strip) may be positioned within the body 100 such that, during use, light will be emitted from one or more surface of the light-transmissive portion 104. Conceptually, the relatively opaque portion 106 may substantially limit or prevent light from being emitted from exterior surfaces of body 100 that are formed of relatively opaque portion 106. Thus, such a configuration may preferentially emit light from the light-transmissive portion 104 during use. As shown in FIGS. 8A-1 to 8F-2 direction Y and direction X are labeled for reference, respectively. As shown in FIGS. 8A-1 to 8F-2 base axis L of light-emitting strip 90 may be oriented generally or substantially in direction Y. Further, the shape and position of upper surface 70 may determine, at least in part, the manner in which light is emitted by flexible light strip 90. In further detail, as shown in FIGS. 8A-1 to 8F-2 in some embodiments, flexible light strip base 91 may be substantially aligned with axis Y. Such a configuration may allow for greater flexibility of the flexible light strip 90 bending about the Y axis, but less flexibility bending about the X axis. Furthermore, in some embodiments, flexible light strip base 91 may be generally oriented in the direction Y, as shown in FIGS. 8A-1 to 8F-2. Such a configuration may allow the flexible light device to be bent, formed, or otherwise positioned to emit light in the form of a selected shape (e.g., bent in the form of an alphanumeric character, symbol, geometric shape, or any indicia).

In some embodiments of the present invention, one or more light-emitting device may be attached to a body. Generally, the embodiments contemplated herein include at least one light-emitting device (e.g., at least elongated light-emitting element). In some embodiments, a plurality of light-emitting devices (e.g., a plurality of elongated light-emitting elements) may be included in a lighting assembly.

Such a configuration may allow for the body to be designed to achieve a desired appearance of the one or more light-emitting device. In some embodiments, silicone, glue, adhesive, one or more clips, one or more fastening element, one or more zip ties, one or more Velcro® fasteners, one or more tongue in groove features, and/or one or more clamps may be used to attach a light-emitting device to a body. In one embodiment, a silicone-based material may be applied or positioned between a body and a light-emitting device (e.g., a silicone sealant may be deposited at more than one location within a groove or recess formed in body and then a light-emitting device may be positioned within the recess). For example, in some embodiments, a silicone material may comprise LEXEL® elastic sealants (commercially available from SASHCO).

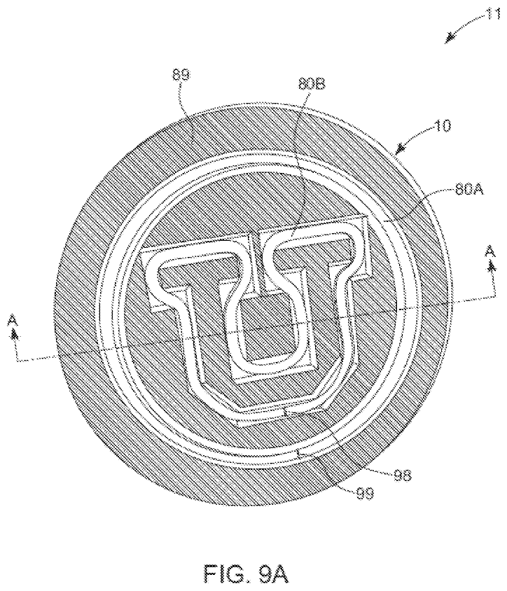

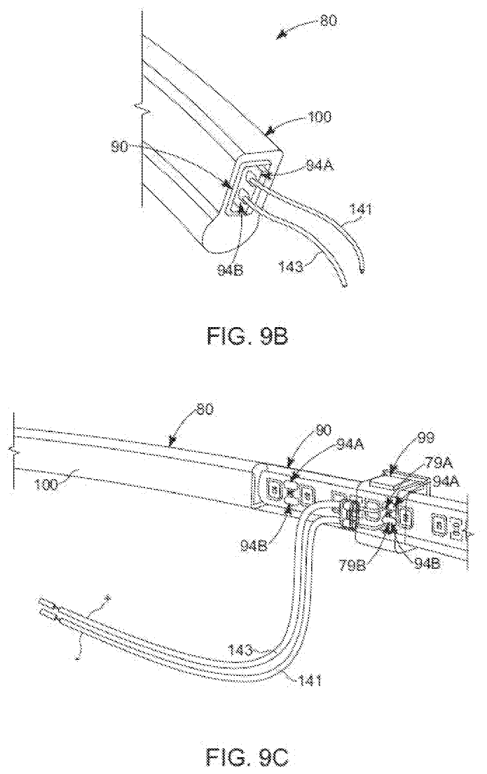

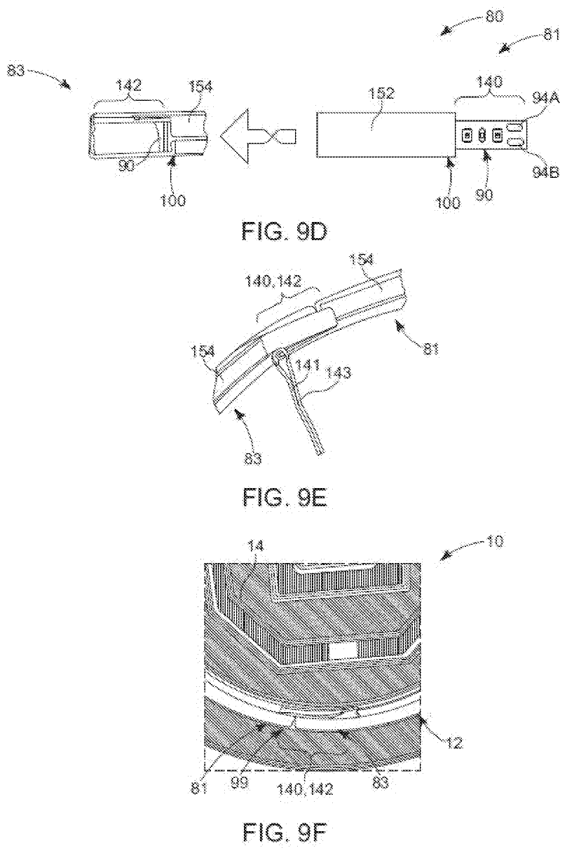

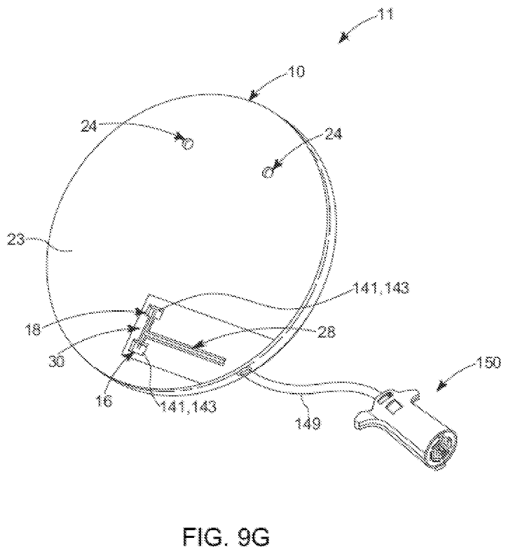

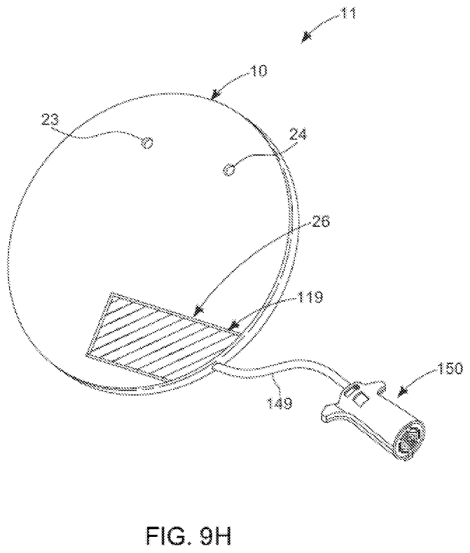

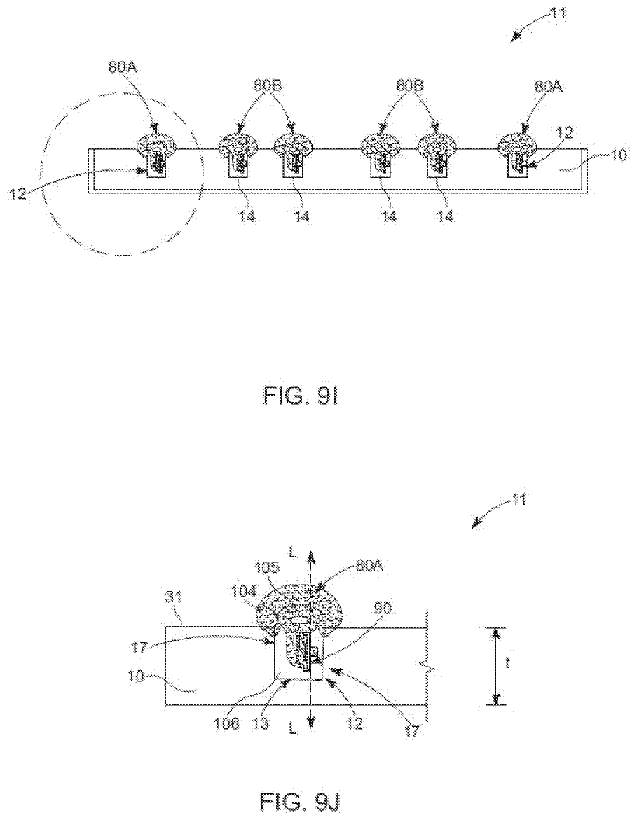

In one embodiment, an elongated light-emitting element may be positioned at least partially within a recess formed by a body. FIG. 9A shows a perspective view of a lighting assembly 11. As depicted in FIG. 9A, body 10 may exhibit a 3D-printing characteristic 89 of being 3D-printed. Explaining further, in some embodiments, layers and/or the deposition paths/directions of the 3D printing process may be detectable (e.g., visually). Such 3D printing characteristic 89 may be present on any portion of a surface of the body 10. As shown in FIG. 9A, elongated light-emitting element 80A may be positioned within groove 12 of body 10. In one embodiment, an adhesive or sealant may be deposited in groove 12 to attach elongated light-emitting element 80A to body 10. Further, a second elongated light-emitting element 80B may be positioned within groove 14. In one embodiment, an adhesive or sealant may be deposited in groove 14 to attach elongated light-emitting element 80B to body 10. Such a configuration, when viewed toward front surface 31 and when the first and second elongated light-emitting element 80A/80B are energized, visually forms a circle (elongated light-emitting element 80A) surrounding a letter U (elongated light-emitting element 80B). More generally, a first elongated light-emitting element may form a letter, number, logo, or other indicia and a second elongated light-emitting element may form a letter, number, logo, or other indicia. In some embodiments, a first elongated light-emitting element may form a letter, number, logo, or other indicia and a second elongated light-emitting element may form a different letter, number, logo, or other indicia. Further, a first elongated light-emitting element 80A may emit a first color and a second elongated light-emitting element 80B may emit a second color. In some embodiments, an elongated light-emitting element may include a RGB (i.e., red, green, blue) or RGBW (red, green, blue, white) LED capable of emitting more than one color and/or multiple colors. Such a configuration may provide a desired appearance when such elongated light-emitting elements are energized.

Further, as may be appreciated, a length of groove 12 may be measured and elongated light-emitting element 80A may be cut such that it may be placed within groove 12. As shown in FIG. 9A, the ends of elongated light-emitting element 80A may be positioned adjacent one another (e.g., contacting or closely spaced from one another) at joint region 99. In addition, joint region 99 may be generally positioned proximate to access hole 16 (FIG. 1). Such a configuration may provide for wiring operably attached to elongated light-emitting element 80A to pass through body 10. After placement of elongated light-emitting element 80A and wiring of elongated light-emitting element 80A, joint region 99 may be covered/coated with an adhesive and/or sealant. Such a configuration may protect electrical connections and/or wiring operably attached to elongated light-emitting element 80A. Similarly, a length of groove 14 may be measured and elongated light-emitting element 80B may be cut such that it may be placed within groove 14. As shown in FIG. 9A, the ends of elongated light-emitting element 80B may be positioned adjacent one another (e.g., contacting or closely spaced from one another) at joint region 98. Further, joint region 98 may be generally positioned proximate to access hole 18 (FIG. 1). Such a configuration may provide for wiring operably attached to elongated light-emitting element 80B to pass through body 10. Such a configuration may protect electrical connections and/or wiring operably attached to elongated light-emitting element 80B. After placement of elongated light-emitting element 80B and wiring of elongated light-emitting element 80B, joint region 98 may be covered/coated with an adhesive and/or sealant.

In further detail, as shown in FIG. 9B, an elongated light-emitting element 80 may be cut to provide access to connection pads 94A and 94B of light-emitting strip 90. In one embodiment, electrical conductors 141 and 143 may make electrical connections (e.g., be soldered to or otherwise electrically connect to) to light-emitting strip 90. In another embodiment, electrical conductors 41 and 43 may be at least partially embedded within a body to at least partially protect or seal the electrical conductors 141 and 143. Electrical conductors 141 and 143 may comprise any suitable electrically conducting structure, such as, for example, insulated wire, bare wire, metal, a metal alloy, or any other suitable electrically conducting structure. In some embodiments, an electrically conducting structure (e.g., separate electrical conductors) may be 3D-printed as a portion of a 3D-printed article.

In another embodiment, as shown in FIG. 9C, an elongated light-emitting element 80 (e.g., a light-emitting strip 90 thereof) may be electrically connected to electrical connectors by way of a solderless connector. In one embodiment, electrical conductors 141 and 143 may make electrical connections to light-emitting strip 90 by solderless connector 99. Solderless connector 99 comprises piecing feature 79A and piercing feature 79B, which are configured to pierce flexible body 100 of elongated light-emitting element 80 and pierce connection pad 94A and connection pad 94B, respectively. Such a configuration may provide a relatively simple way to make electrical connections to elongated light-emitting element 90. Electrical conductors 141 and 143 may comprise any suitable electrically conducting structure, such as, for example, insulated wire, bare wire, metal, a metal alloy, or any other suitable electrically conducting structure.

In another aspect of the present invention, a portion of flexible body 100 may be removed from one end portion of elongated light-emitting element 80 to expose a portion of the light-emitting strip 90 and a portion of relatively opaque portion of flexible body 100 of the distal end of an elongated light-emitting element 80 may be removed. For example, FIG. 9D shows an elongated light-emitting element 80 with an end region 81 and a distal end region 83. As shown in FIG. 9D, exposed strip 140 may extend from flexible body 100. Such a configuration may provide advantages for making electrical connections to connection pads 94A/94B. FIG. 9D shows a twisted, schematic of elongated light-emitting element 80, wherein end region 81 shows front surface 152, while distal end region 83 shows back surface 154 (i.e., the ends of elongated light-emitting element 80 have been twisted 180 degrees relative to one another). Further, as shown in FIG. 9D, within opened region 142, the light-emitting strip 90 and at least the relatively opaque portion of flexible body 100 (e.g., forming back surface 154) has been removed.

Further, end region 81 and end region 83 (not twisted, since back surface 154 of both end region 81 and distal end region 83 is facing out of the page) may overlap to allow the exposed strip 140 to emit light into opened region 142. As shown in FIG. 9E, the exposed strip 140 may overlap (i.e., create an overlapping region) with opened region 142 of the elongated light-emitting element 80 at or proximate to a joint region (e.g., joint region 98 or joint region 99, as shown in FIG. 9A). Such a configuration may provide more uniform lighting at or proximate to a joint region. In addition, FIG. 9E shows electrical conductors 141, 143, which are attached to connection pads 94A/94B (not shown in FIG. 9E). As shown in FIG. 9E, electrical conductors 141, 143 may extend substantially or generally transverse to elongated light-emitting element 80 (i.e., the axis along which elongated light-emitting element 80 extends).

Such a configuration may be employed relative to a joint region positioned in a groove or recess in which an elongated light-emitting element may be positioned. For example, as shown in FIG. 9F (depicting a partial view of body 10 and elongated light-emitting element 80), elongated light-emitting element 80 may be positioned in groove 12 of body 10, wherein a portion of relatively opaque portion of the distal end 83 of elongated light-emitting element 80 may be removed in opened region 142 (as well as the light-emitting strip in at least a portion of such opened region 142) such that the overlapping exposed light-emitting strip 140 is positioned adjacent to the opened region 142 and will emit light into the relatively transparent portion of the distal end 83 of the elongated light-emitting element 80. Such a configuration may provide more uniform lighting at or proximate to a joint region 99.

In a further aspect of the present invention, electrical conductors operably connected to an elongated light-emitting element may pass through body (e.g., from a front side to a back side). FIG. 9G shows a perspective view of one embodiment of body 10 viewed toward its back surface 23. As shown in FIG. 9G, electrical conductors 141, 143 may pass through access holes 16, 18, respectively. Put another way, each electrical conductor 141, 143 from elongated light-emitting element 80A may pass through access hole 16. Similarly, each electrical conductor 141, 143 from elongated light-emitting element 80B may pass through access hole 18. As shown in FIG. 9G, electrical conductors 141, 143 may be positioned in wiring channels 28 and 30. In one embodiment, electrical conductors 141, 143 of each of elongated light-emitting elements 80A/80B may be electrically connected to wiring 149. In one embodiment, wiring 149 may be an insulated wire (e.g., suitable for outdoor use) containing two conductors. Further, as shown in FIG. 9G, wiring 149 may be operably attached to electrical plug 150. Although electrical plug 150 is depicted in FIG. 9G as being a so-called 7-blade trailer plug, the present invention contemplates that electrical plug 150 may comprise any suitable electrical plug, without limitation. For example, electrical plug 150 may comprise a cigarette lighter plug, 4-way flat or round plugs, 5-way flat or round plugs, 6-way flat or round plugs, 7-way blade or pin plugs, or any vehicle plug as known in the art. In other examples, an alternating current plug (e.g., a 110-volt household male plug connector) may be used with or without a voltage converter.

In some embodiments, after electrical connections between at least one light-emitting device and a suitable plug has been completed, wiring channels 28, 30 as well as access holes 16, 18 may be at least partially filled with a sealant (e.g., a silicone or rubber sealant). Such a configuration may protect electrical connections and/or any exposed electrical conductors. Further, in some embodiments, as shown in FIG. 9H, a cover element 119 may be positioned generally over cover recess 26. Such a configuration may protect electrical connections and wiring. In some embodiments, cover element 119 may comprise a polymer sheet, metal sheet, or another suitable cover for cover recess 26. For example, in one embodiment, cover element 119 may comprise so-called “edge banding” material. Accordingly, cover element may comprise melamine, PVC, aluminum, wood, acrylic, mylar, or any other edge banding material. Edge banding may be available commercially from Product Resources, Inc. DBA, PRI Edgebanding of Gurnee, IL, Home Depot®, Lowe's®, Walmart®, and other suppliers. In some embodiments, cover element 119 may comprise a sheet material with hot melt glue covering a back surface. Such a configuration may allow for cover element 119 to be “ironed” (or otherwise heated while compressing cover element 119 against body 10) in order to attach cover element 119 to body 10. In other embodiments, an adhesive or sealant may be used to attach cover element 199 to body 10.

In further detail, FIG. 9I shows a cross-sectional view A-A of body 10 (FIG. 9A). As shown in FIG. 9I, elongated light-emitting element 80A and elongated light-emitting element 80B may be positioned at least partially within grooves 12 and 14, respectively. In addition, FIG. 9J shows an enlarged partial view of the cross-sectional view of body 10 shown in FIG. 9I. As shown in FIG. 9J, elongated light-emitting element 80A may be positioned at least partially within groove 12. Further, adhesive 13 may be positioned between elongated light-emitting element 80A and groove 12. As discussed herein, elongated light-emitting element 80A may comprise a light-emitting strip 90, a light-transmissive portion 104 and a relatively opaque portion 106. Further, in some embodiments and as shown in FIG. 9J, elongated light-emitting element 80A may comprise (and define) a cavity 105. As shown in FIG. 9J, base axis L of light-emitting strip 90 may be oriented generally parallel to side walls 17 of groove 12. In some embodiments, base axis L of light-emitting strip 90 may be oriented within 2°-15° of side walls 17 of groove 12.

As mentioned above, an assembly of a structural element and a body may be advantageous. In some embodiments, a structural element and a 3D-printed article may be selected to reduce cost and/or 3D printing time of the 3D-printed article. In other embodiments, a structural element and a body may be selected to reduce cost and/or machining/forming time of the body. In some embodiments, as shown in FIG. 9J, a thickness “t” (e.g., a smallest dimension of a body to be 3D-printed or otherwise formed) of body may be selected to be less than 2 inches, between 2 inches and 0.5 inches, less than 1.5 inches, between 1.5 inches and 0.5 inches, less than 1 inch, between 1 inch and 0.5 inches, between 0.3 inches and 1 inch, between 0.25 inches and 0.75 inches, or between 0.3 inches and 0.6 inches. Such a configuration may, in some embodiments, reduce cost and/or 3D printing time of body 10. Further, in some embodiments, when a structural element is attached to body 10 (as shown in FIG. 9J, a dimension of the structural element corresponding to thickness t of body 10 may exceed the thickness t of body 10. In some embodiments, a dimension of the structural element corresponding to the direction in which thickness t is measured may be more than 2 times thickness t, more than 3 times thickness t, more than 4 times thickness t, more than 5 times thickness t, between more than 3 times thickness t and 5 times thickness t, or between 4 times thickness t and 6 times thickness t. Such a configuration may, in some embodiments, reduce cost and/or 3D printing time of body 10.

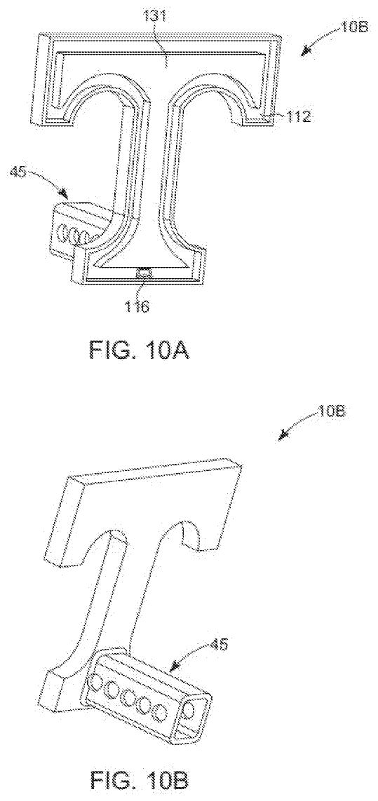

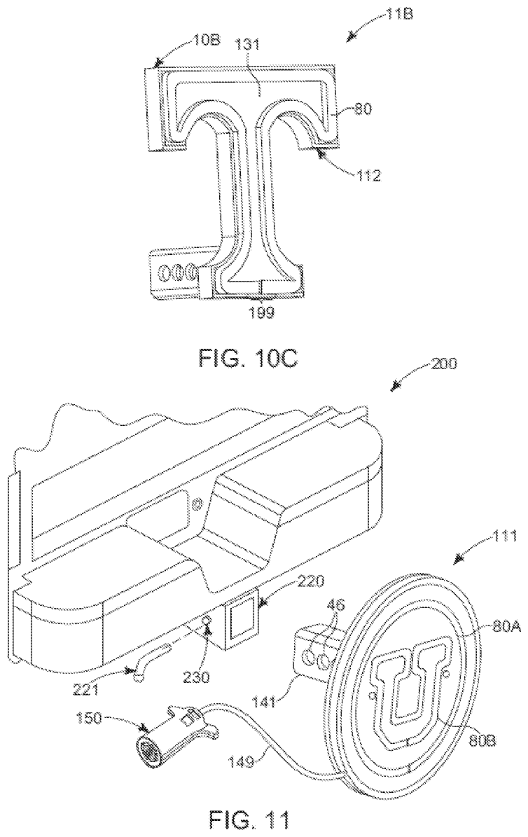

FIG. 10A shows perspective view of body 10B. As shown in FIG. 10A, body 10B may include an inset groove 112 and access hole 116. An inset groove, as used herein, means a groove that follows (or substantially follows) the periphery of a 3D shape. As shown in FIG. 10A, a body 10B may comprise an inset groove 112 and an elongated light-emitting element positioned at least partially therein may form a letter, number, logo, or other indicia. In some embodiments, an elongated light-emitting element may form a letter, number, logo, or other indicia. Generally, as described with respect to body 10, body 10B may include one or more wiring channel extending, one or more wiring port, and one or more access hole. Such a configuration may allow for an electrical plug (e.g., a trailer plug or any suitable electrical plug) to supply electricity to at least one light-emitting device (not shown) positioned at least partially in grooves 12. As shown in FIGS. 2A and 2B and as described in further detail herein, body 10B may comprise a cover recess sized and configured for a cover element (not shown) to be attached thereto (e.g., to cover wiring disposed in wiring channels (not shown). Further, as shown in FIGS. 10A and 10B, body 10B and a structural element 45 may be attached to one another. As described herein relative to any other embodiments, body 10B and structural element 45 may be adhesively bonded (e.g., glued), welded, and/or attached to one another via one or more fastening element.

Further, in one embodiment, an elongated light-emitting element may be positioned at least partially within a recess formed by a body. As shown in FIG. 10C, elongated light-emitting element 80 may be positioned within groove 112 of body 10B. In one embodiment, an adhesive or sealant may be deposited in groove 112 to attach elongated light-emitting element 80 to body 10B. Such a configuration, when viewed toward front surface 131 and when the elongated light-emitting element 80 is energized, visually forms a letter “T” (elongated light-emitting element 80). Accordingly, elongated light-emitting element may form a letter, number, logo, or other indicia. In some embodiments, one or more elongated light-emitting elements may form or depict a flag, icon, symbol, emoji, logo, or any other indicia. Elongated light-emitting element 80 may emit a selected color. In some embodiments, an elongated light-emitting element may include a RGB (i.e., red, green, blue) or RGBW (red, green, blue, white) LED capable of emitting more than one color and/or multiple colors. Such a configuration may provide a desired appearance when one or more elongated light-emitting elements are energized.

Further, as may be appreciated, a length of groove 112 may be measured and elongated light-emitting element 80 may be cut such that it may be placed within groove 112. As shown in FIG. 10C, the ends of elongated light-emitting element 80 may be positioned adjacent one another (e.g., contacting or closely spaced from one another) at joint region 199. In addition, joint region 199 may be generally positioned proximate to access hole 116 (FIG. 10A). Such a configuration may provide for wiring operably attached to elongated light-emitting element 80 to pass through body 10B. After placement of elongated light-emitting element 80 and wiring of elongated light-emitting element 80, joint region 199 may be covered/coated with an adhesive and/or sealant. Such a configuration may protect electrical connections and/or wiring operably attached to elongated light-emitting element 80.

In a further aspect of the present invention, a lighting assembly may be painted or coated with a material. Such a configuration may improve the appearance of the lighting assembly. In one embodiment, a lighting assembly may be at least partially painted (e.g., either before or after a light-emitting device is attached to a body). Such a configuration may at least partially cover a joint (e.g., a region of contact between) between structural element and a body and/or cover one or more fastening elements attaching a structural element to a body. In another embodiment, a lighting assembly may be at least partially coated with a coating. For example, a lighting assembly may be at least partially coated with a coating comprising rubber, silicone, or any suitable coating or sealant. In one embodiment, a light assembly may be at least partially coated with PLASTI DIP® rubberized coating (commercially available from Plasti Dip International located in Blaine, Minnesota; available in aerosol cans or liquid).

In a further aspect of the present invention, any portion of a body may be heated and deformed. For example, a surface of a body may be ironed to “smooth” a surface thereof. For example, a surface of a body may be heated by contacting a heated component against the body (or vice versa). In one embodiment, the body may be placed against a heated surface (e.g., an iron, a glass burner/stovetop, a ceramic burner/stovetop, or any other suitable heated article). Optionally, a non-stick film or paper (e.g., parchment paper, Teflon®, silicone, etc.) may be placed between the heated surface and the body, to inhibit or prevent the body from sticking to the heated surface.

Turning to FIG. 11, FIG. 11 shows a back partial view of a vehicle 200 and a lighting assembly 111 including at least one body. Vehicle 200 includes a receiver 220 As shown in FIG. 11, lighting assembly 111 may be attached to the vehicle 200 via structural element 141 (e.g., structural element 41, 43, or 45, as shown in FIGS. 4A, 4B, and 4C). Such lighting assembly 111 may be attached to vehicle 200 by inserting structural element 141 into receiver 220, aligning one of pin holes 46 with receiver pin hole 230, and inserting pin 221 through receiver 220 and structural element 141. In addition, such lighting assembly 111, via electrical plug 150, may be operably connected to a suitable electrical source (e.g., a trailer hitch electrical socket (not shown)).

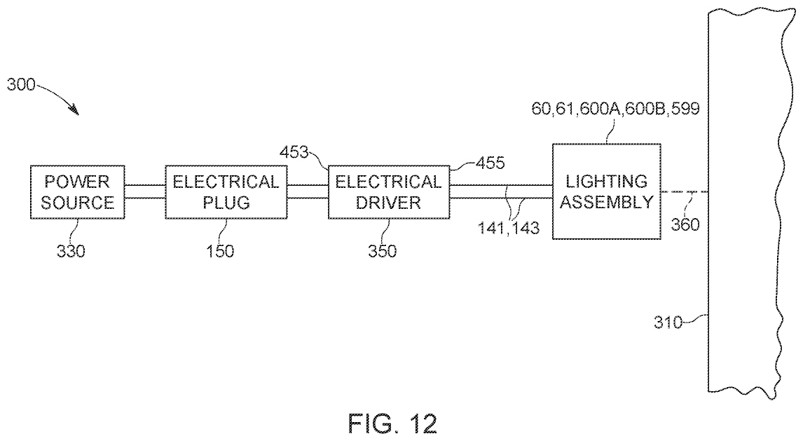

In some embodiments, a lighting assembly may be attached to a vehicle, a house, a wall, a window, or any other structure. Schematically, FIG. 12 shows a block diagram of a system 300 including at least one lighting assembly 60, 61, 600A, 600B, 599, (lighting assemblies 600A, 600B, and 599 are described in further detail below) where electrical conductors 141, 143 pass from lighting assembly 60, 61, 600A, 600B, 599 to electrical plug 150. Further, electrical plug 150 may be operably coupled to a power source 330 (e.g., a 12-volt battery, a 120 alternating current household plug, or any suitable power source) and may be used to energize lighting assembly 60, 61, 600A, 600B, 599. Optionally, in some embodiments, electrical conductors 141, 143 may be operably connected to an electrical driver 350 (e.g., for converting from a selected voltage of alternating current to a selected voltage of direct current, for converting from a selected voltage of direct current to a selected voltage of direct current, for providing a relatively constant current, etc.) having a power output equal to or greater than the power requirements for operating the at least one light-emitting device (e.g., at least one elongated light-emitting element). Optionally, in some embodiments, system 300 may comprise (e.g., within electrical driver 350 or as one or more standalone component) an electrical switch and/or a dimmer (e.g., adjustable voltage and/or current) for adjusting the brightness of the light emitted by the lighting assembly 60, 61, 600A, 600B, 599. For example, such a dimmer may comprise an adjustable LED driver (e.g., such as a LED PWM Controller and/or a Constant Current Converter, such as a DC-DC Step-Down or Step-Up converter). In some embodiments, an adjustable LED driver may be configured to provide between 10 watts and 20 watts of power, between 5 watts and 10 watts of power, between 20 watts and 30 watts of power, or any other suitable range of wattage.

In one embodiment, an electrical driver 350 may be a direct current to direct current step-up or boost converter. For example, an electrical driver 350 may convert 10-32 volts direct current at its input 453 to 12-50 volts at its output 455 (i.e., to lighting assembly 60, 61, 600A, 600B, 599) and may have a selected power rating (e.g., at least about 5 watts, at least about 10 watts, at least about 10 watts, at least about 20 watts, at least about 40 watts, greater than about 50 watts, between about 5 watts and about 15 watts, or between about 10 watts and about 50 watts). However, in some embodiments, electrical driver 350 may be omitted and power source 330 may energize lighting assembly 60, 61, 600A, 600B, 599 directly. As further shown in FIG. 12, lighting assembly 60, 61, 600A, 600B, 599 may be attached to structure 310 via attachment mechanism 360. In some embodiments, attachment mechanism 360 may comprise a structural element, a fastener or fastening element, a magnet, or any other suitable attachment mechanism, without limitation.

In further aspects of the present invention, control circuits (e.g., for controlling one or more color of a light-emitting device, controlling energizing and turning off light-emitting device, and/or controlling a voltage supplied to light-emitting device), timing circuits, protection circuitry (e.g., protection from overheating a light-emitting device, protection from supplying excessive electrical current/voltage to a light-emitting device, etc.) may be used in combination with the lighting assemblies and systems disclosed herein. It will be appreciated that such control circuits may be a separate assembly or may be integrated into the electrical driver. Furthermore, the present invention contemplates that other light-emitting devices may be included in the lighting assemblies described above. For example, in some embodiments, at least one laser diode (e.g., at least one double heterostructure laser, at least one quantum well laser, at least one quantum cascade laser, at least one separate confinement heterostructure laser, at least one distributed Bragg Reflector laser, at least one distributed feedback laser, at least one VCSEL, at least one VECSEL, or at least one external-cavity diode laser) may be included in the lighting assemblies described above. In such a configuration, the at least one laser diode may be separately wired (e.g., via electrical conductors), powered (e.g., via power sources, voltage converters, current limiters, etc.), and controlled.

In a further aspect of the invention, a 3D-printed article may comprise a translucent material, semi-transparent, and/or a transparent material. In one embodiment, a 3D-printed article may comprise one or more of a translucent (or transparent) material comprising PLA, ABS, EVA, PETG (Polyethylene terephthalate glycol), nylon, acrylonitrile styrene acrylate (ASA), TPE, TPU, PEKK, polypropylene, polycarbonate, carbon fiber reinforced filament material, glass reinforced filament material, filament material including metal particles, and electrically conductive filament material, without limitation.

In any of the disclosed embodiments described with respect to FIGS. 1-12, a translucent, semi-transparent, or transparent 3D-printed article may be utilized. As used herein, the phrase “transmissive 3D-printed article” or “transmissive 3D-printed body” shall mean a 3D-printed article comprising a translucent, semi-transparent, or transparent material (however, a transmissive 3D-printed body may have a color or hue, without limitation). For example, in one embodiment, an elongated light-emitting element may be positioned at least partially within a recess formed by a transmissive 3D-printed body.

In another aspect of the present invention, in one embodiment, a light-emitting element may be configured and positioned such that light it emits at least partially passes into or through the transmissive 3D-printed body. In one embodiment, the light-transmissive portion of an elongated light-emitting element may be positioned at least partially within a groove formed by the transmissive 3D-printed body. Thus, such a configuration may preferentially emit light into or toward a transmissive 3D-printed body, thereby at least partially illuminating the transmissive 3D-printed body.

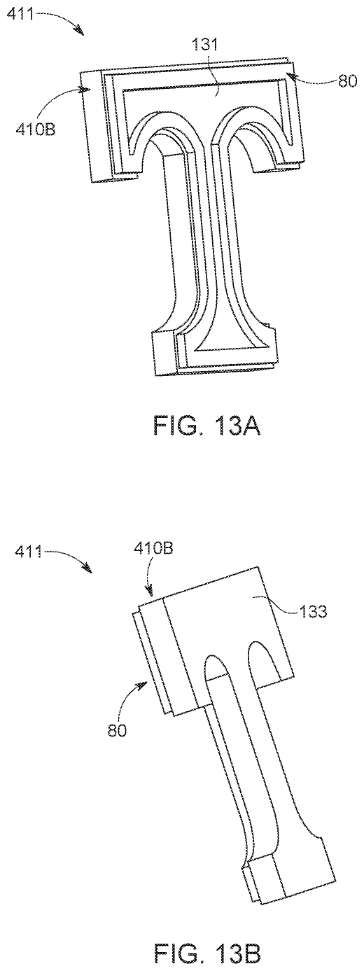

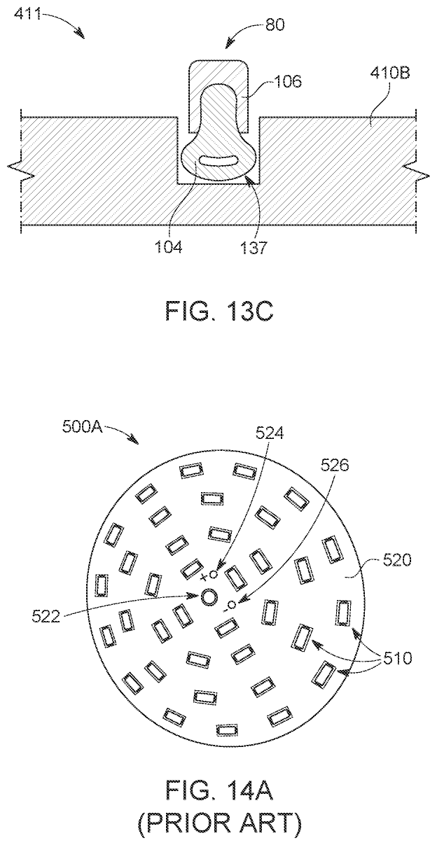

FIGS. 13A and 13B show respective perspective view of a lighting assembly 411 comprising transmissive 3D-printed body 410B. In general, transmissive 3D-printed body 410B may include at least one groove (as described with respect to any 3D body shown in FIGS. 1-10C). More specifically, in one embodiment and as shown in FIG. 13A, a transmissive 3D-printed body 410B may comprise an inset groove 112 and an elongated light-emitting element 80 positioned at least partially therein may form a letter, number, logo, or other indicia. However, as further depicted in FIG. 13C, which shows a partial cross-sectional view of transmissive 3D-printed body 410B and elongated light-emitting element 80, the light-emitting surface 137 of elongated light-emitting element 80 may be positioned at least partially within a recess of transmissive 3D-printed body 410B such that it is positioned proximate to bottom surface 113 of groove 112. As described herein, elongated light-emitting element 80 includes a relatively opaque portion 106 and a light-transmissive portion 104. 625

In one embodiment, an adhesive or sealant may be deposited (e.g., in groove 112) to attach elongated light-emitting element 80 to transmissive 3D-printed body 410B. Such a configuration, when viewed toward back surface 133 and when the elongated light-emitting element 80 is energized, visually forms a letter “T” (elongated light-emitting element 80), when viewed toward back surface 133. Accordingly, elongated light-emitting element 80 may form a letter, number, logo, or other indicia by at least partial transmission of light into and/or through transmissive 3D-printed body 410B. In some embodiments, one or more elongated light-emitting elements may form or depict a flag, icon, symbol, emoji, logo, or any other indicia. Optionally, elongated light-emitting element 80 may emit a selected color or colors. In some embodiments, an elongated light-emitting element 80 may include a RGB (i.e., red, green, blue) or RGBW (red, green, blue, white) LED capable of emitting more than one color and/or multiple colors. Such a configuration may provide a desired appearance when one or more elongated light-emitting elements are energized. Optionally, the light passing through the 3D-printed article (body 410B) may cause at least a portion of the infill of such 3D-printed article to be visually discernable.

Further, as may be appreciated, a length of groove 112 may be measured and elongated light-emitting element 80 may be cut such that it may be placed within groove 112. However, in some embodiments, transmissive 3D-printed body 410B may not include an access hole (e.g., access hole 116, as shown in FIG. 10A). In other embodiments, transmissive 3D-printed body 410 may include one or more channel, access hole, recess, groove, or feature for wiring that is connected to elongated light-emitting element 80. Accordingly, in one embodiment, wiring may be operably attached to elongated light-emitting element 80 and extend therefrom along or away from front surface 131. After placement of elongated light-emitting element 80 and wiring of elongated light-emitting element 80, one or more joint region (not shown) may be covered/coated with an adhesive and/or sealant. Such a configuration may protect electrical connections and/or wiring operably attached to elongated light-emitting element 80.

In a further aspect of the present invention, a lighting assembly may comprise a vinyl graphic. Such a configuration may improve the appearance of the lighting assembly. For example, a vinyl graphic may be positioned upon at least a portion of back surface 133. In some embodiments, a vinyl graphic may be positioned at least partially within groove 112.

In another embodiment, a lighting device may be utilized in combination with a translucent, semi-transparent, or transparent 3D-printed article such that light passes through the 3D-printed article. Optionally, the light passing through the 3D-printed article may cause the infill of such 3D-printed article to be at least partially visually discernable. In some embodiments, at least one of the lighting device and a transmissive 3D-printed body may be sized and configured such that the infill of the 3D-printed article is visually discernable when the lighting device is energized. Furthermore, in some embodiments, an infill pattern of a transmissive 3D-printed article may be selected (e.g., shape, size, etc.) to create a desired visual effect (e.g., a pleasing visual effect).

In some embodiments, a panel lighting device may comprise one or more of an SMD board (e.g., a circuit board including a plurality of LEDs), a light engine, a light module, a COB board, a light panel (e.g., a NANOLEAF® light panel, a GOVEE® light panel, a YESCOM® light panel, any “smart” light panel, etc.), an LED light sheet, an addressable light device (e.g., a WS2811, WS2812, WS2812B, WS2813, or other selectively controlled light matrix, strip, or panel). Further, such one or more panel lighting device may be used in combination with a transmissive 3D-printed article. Lighting devices may be commercially available from, for example, superbrightleds.com, LEDsupply.com, aliexpress.com, amazon.com, Mouser Electronics, among others. In some embodiments, a panel lighting device may have a light-emitting area which is substantially planar, curved, or a combination of substantially planar and curved. In some embodiments, a lighting emitting area may have a surface upon which LEDs are spaced from one another in a selected pattern. Optionally, an area of a surface over which such LEDs are spaced may be between 9 square inches and 16 square inches, between 16 square inches and 25 square inches, between 10 square inches and 20 square inches, between 12 square inches and 52 square inches, between 18 square inches and 32 square inches, between 40 square inches and 49 square inches, between 45 square inches and 64 square inches, or between 64 square inches and 200 square inches, or between 64 square inches and 100 square inches.

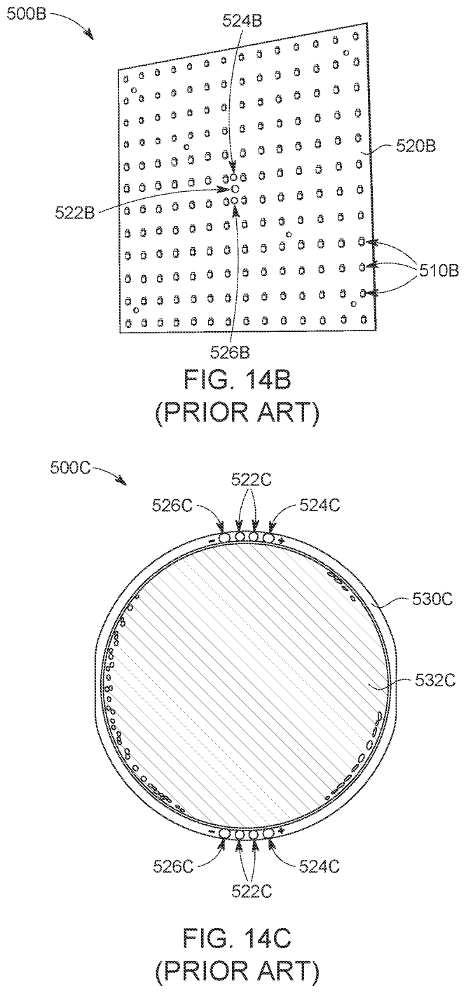

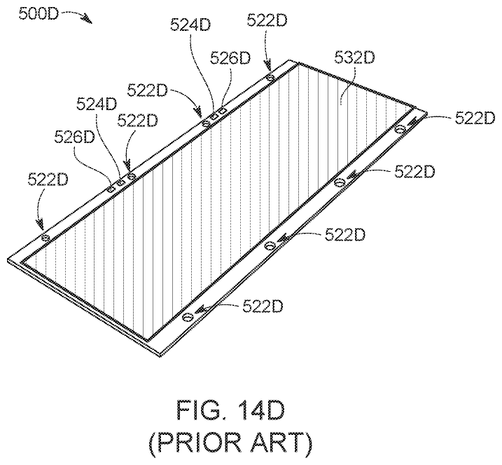

In one embodiment, a panel lighting device may include a substrate and a circuit attached thereto (e.g., formed thereon). In one embodiment a panel lighting device may include a metal substrate with one or more circuit layer, one or more dielectric layer, and a plurality of LEDs. FIG. 14A shows a perspective view of one embodiment of a panel lighting device of a known type comprising a so-called SMD board 500A with a plurality of LEDs 510 operably attached thereto (e.g., soldered). As shown in FIG. 14A, the substrate 520 is generally round and has a disc shape (i.e., its thickness is relatively small in comparison to its largest dimension). Substrate 520 may comprise a metal (e.g., aluminum, copper, etc.). Further, the aluminum substrate 520 defines hole 522. Such hole 522 may allow for wiring to pass through substrate 520 and to be soldered to solder pads 524, 526. Optionally, substrate 520 may have at least one additional hole, which may be used for fastening the SMD board 500A to a transmissive 3D-printed body.

FIG. 14B shows a perspective view of one embodiment of a panel lighting device of a known type comprising a so-called SMD board 500B with a plurality of LEDs 510B operably attached thereto (e.g., soldered). As shown in FIG. 14B, the substrate 520B is somewhat rectangular (e.g., square) and has a flat, thin shape (i.e., its thickness is relatively small in comparison to its largest dimension). Substrate 520B may comprise a metal (e.g., aluminum, copper, etc.). Further, the aluminum substrate 520B defines hole 522B. Such hole 522B may allow for wiring to pass through substrate 520B and to be soldered to solder pads 524B, 526B. Optionally, substrate 520B may have at least one additional hole, which may be used for fastening the SMD board 500B to a transmissive 3D-printed body.

In some embodiments, SMD board 500A or SMD board 500B may be configured to operate 5-60 volts direct current and may have a selected power rating (e.g., at least about 5 watts, at least about 10 watts, at least about 10 watts, at least about 20 watts, at least about 40 watts, greater than about 50 watts, between about 5 watts and about 15 watts, between 10 watts and 30 watts, between 2 watts and 10 watts, between 3 watts and 8 watts, between 4 watts and 8 watts, between 2 watts and 5 watts, or between about 10 watts and about 50 watts).

FIG. 14C shows a perspective view of one embodiment of a panel lighting device of a known type comprising a so-called COB board 500C comprising a plurality of “bare die” chips (not shown) and a phosphor coating area 532C over the plurality of chips. In some embodiments, phosphor coating area 532C may exhibit a generally “yellow” color or may be otherwise suitably configured in any other configuration as known in the art. As shown in FIG. 14C, the substrate 530C is generally round and has a disc shape (i.e., its thickness is relatively small in comparison to its largest dimension). Substrate 530C may comprise a metal (e.g., aluminum, copper, etc.), a ceramic, or any other suitable material. Further, as shown in FIG. 14C, the substrate 530 defines holes 522C. One or more of holes 522C may allow for wiring to pass through substrate 520 and to be soldered to solder pads 524C, 526C or may be used to mount COB board 500C to another structure or to a transmissive 3D-printed body. As shown in FIG. 14C, phosphor coating area 532C may cover a substantial portion of a surface of substrate 530C. For example, in some embodiments, phosphor coating area 532C may cover between 30% and 50% of the surface area on which it is formed, between 50% and 70% of the surface area on which it is formed, between 70% and 90% of the surface area on which it is formed, or between 90% and 99% of the surface area on which it is formed.

FIG. 14D shows a perspective view of one embodiment of a panel lighting device of a known type comprising a so-called COB board 500D comprising a plurality of “bare die” chips (not shown) and a phosphor coating area 532D over the plurality of chips. As shown in FIG. 14D, the substrate 530D is generally rectangular and has a disc shape (i.e., its thickness is relatively small in comparison to its largest dimension). Substrate 530D may comprise a metal (e.g., aluminum, copper, etc.), a ceramic, or any other suitable material. Further, as shown in FIG. 14C, the substrate 530D defines holes 522D. One or more of holes 522D may allow for wiring to pass through substrate 520 and to be soldered to solder pads 524D, 526D or may be used to mount COB board 500D to another structure or to a transmissive 3D-printed body. As shown in FIG. 14D, phosphor coating area 532D may cover a substantial portion of a surface of substrate 530D. For example, in some embodiments, phosphor coating area 532D may cover between 30% and 50% of the surface area on which it is formed, between 50% and 70% of the surface area on which it is formed, between 70% and 90% of the surface area on which it is formed, or between 90% and 99% of the surface area on which it is formed.

In some embodiments, COB board 500C or 500D may be configured to operate 5-60 volts direct current and may have a selected power rating (e.g., at least about 5 watts, at least about 10 watts, at least about 10 watts, at least about 20 watts, at least about 40 watts, greater than about 50 watts, 50 watts to 100 watts, 100 watts to 200 watts, between about 5 watts and about 15 watts, between 10 watts and 30 watts, between 30 watts and 50 watts, between 2 watts and 10 watts, between 3 watts and 8 watts, between 4 watts and 8 watts, between 2 watts and 5 watts, or between about 10 watts and about 50 watts). In some embodiments, a size of the area of a phosphor coating 532C or 532D may be between 9 square inches and 16 square inches, between 16 square inches and 25 square inches, between 10 square inches and 20 square inches, between 12 square inches and 52 square inches, between 18 square inches and 32 square inches, between 40 square inches and 49 square inches, between 45 square inches and 64 square inches, or between 64 square inches and 200 square inches, or between 64 square inches and 100 square inches.

In some embodiments, a panel lighting device (e.g., 500A, 500B, 500C, or 500D) may be configured with a dimmer that provides a selected wattage to a panel lighting device. In some embodiments, a panel lighting device (e.g., 500A, 500B, 500C, or 500D) may be configured with a dimmer that provides less than 50% of the maximum wattage of such panel lighting device. Such a configuration may be at least partially because panel lighting devices with relatively high wattage may be used for lighting streets, parking lots, homes, and/or businesses. In some embodiments, a dimmer may provide between 50% to 30% of the maximum wattage of a panel lighting device, between 30% to 20% of the maximum wattage of a panel lighting device, between 20% to 10% of the maximum wattage of a panel lighting device, or between 10% to 5% of the maximum wattage of a panel lighting device. For example, In some embodiments, a dimmer may provide, to a panel lighting device, less than about 5 watts, less than about 10 watts, less than about 20 watts, less than about 40 watts, less than about 50 watts, between about 5 watts and about 15 watts, between 10 watts and 30 watts, between 2 watts and 15 watts, between 3 watts and 8 watts, between 4 watts and 8 watts, between 2 watts and 5 watts, or between about 10 watts and about 50 watts. Operating a panel lighting device at a selected wattage which is relatively low compared to its maximum wattage may be advantageous in extending the life of such panel lighting device.

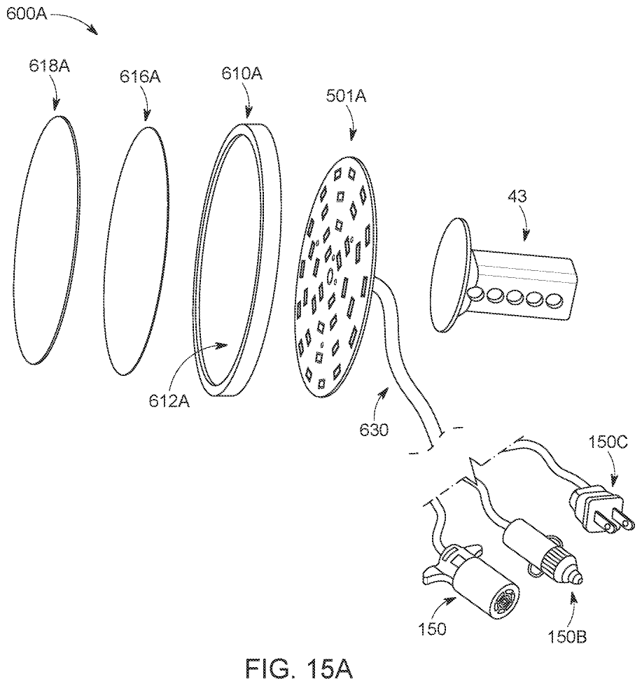

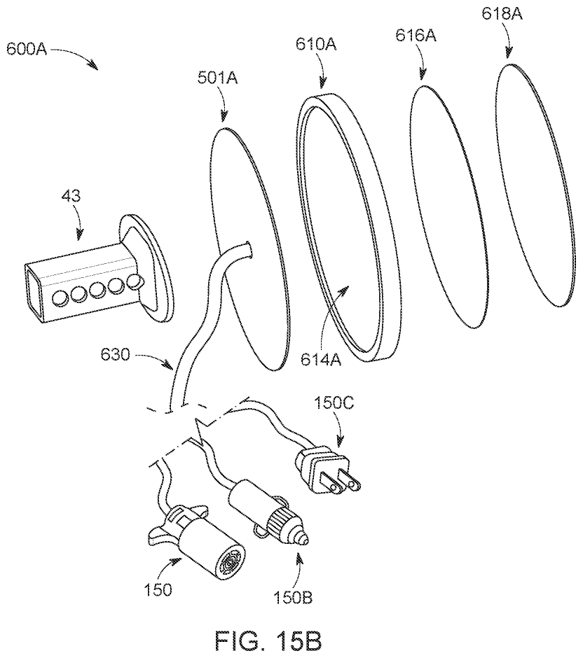

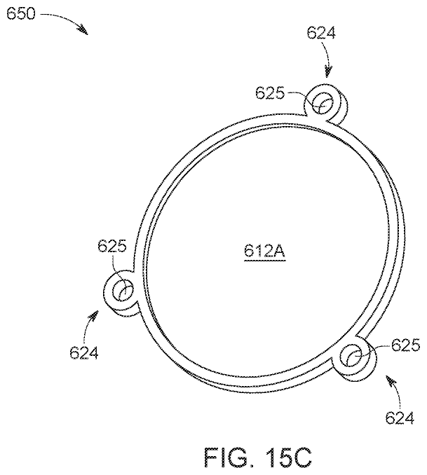

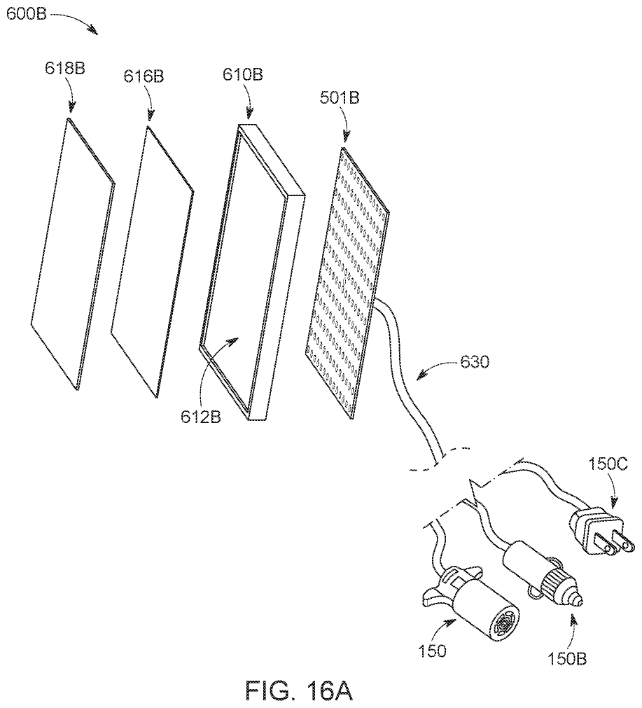

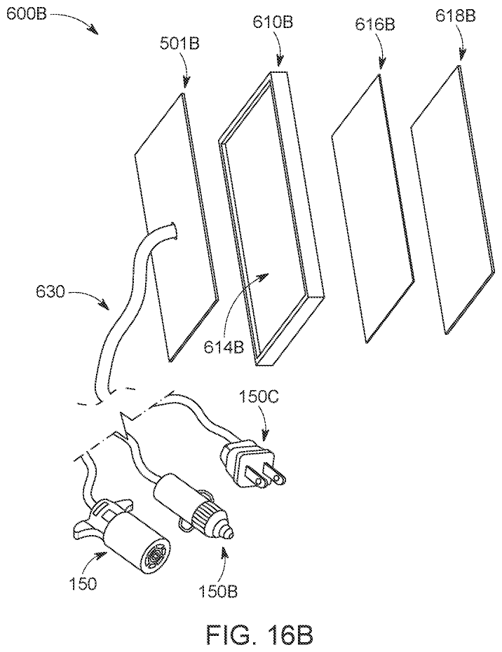

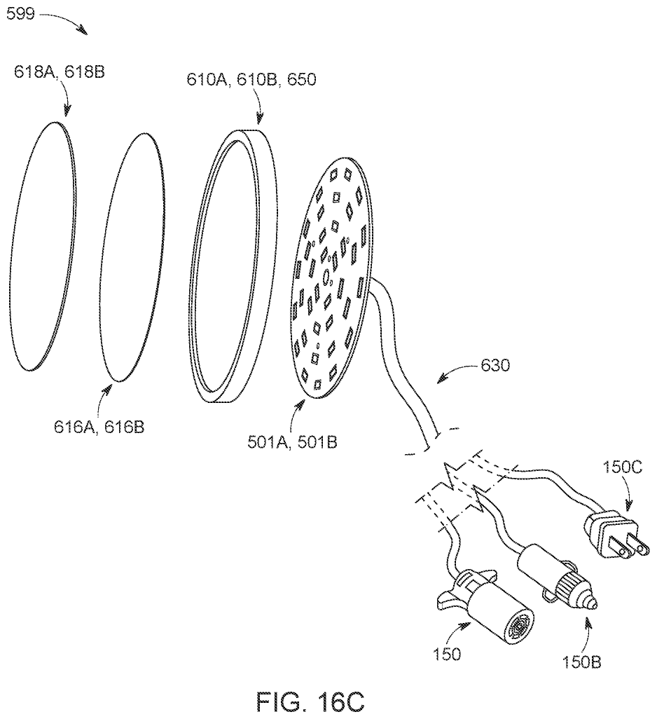

Further, in any of the disclosed embodiments described with respect to FIGS. 15A-16B, an at least partially translucent, semi-transparent, or transparent graphic element may be utilized. As used herein, the phrase “transmissive graphic element” shall mean a graphical depiction formed from and/or upon a translucent, semi-transparent, or transparent material. For example, in one embodiment, a panel lighting device may be positioned at least partially within a recess formed by a transmissive 3D-printed body and a transmissive graphic element may be positioned on the other side of the transmissive 3D-printed body such that light passing through the transmissive 3D-printed body also illuminates the transmissive graphic element.

In some embodiments, a transmissive graphic element (e.g., transmissive graphic element 616A/616B as shown in FIGS. 15A-16B) may comprise a so-called transparency sheet upon which a printed image, indicia, alphanumeric character, symbol, geometric shape, or any indicia (e.g., a collegiate symbol, collegiate sport-related indicia, professional sport symbol, professional sport-related indicia, etc.) may be formed. In some embodiments a transmissive graphic element may be formed by ink-jet printing, laser printing, screen printing, or any other suitable method. In some embodiments, transmissive graphic element may comprise UV-curable printing and/or digital ceramic printing may be used in combination with a transparent, translucent, or otherwise light-transmissive material to create a transmissive graphic element. Digital UV printing technology uses organic inks and ultraviolet light to cure the ink and may be adhered to the surface of a substrate, (e.g., a transparent, translucent, or otherwise light-transmissive substrate, such as, for example, glass, acrylic, polyethylene, transparency sheet material, a transmissive 3D-printed body, a lens element, etc.). Digital UV printing technology enables expansive color combinations and is a fast and economical method for printing high-quality, customizable images. Digital ceramic printing uses inks that contain ceramic frit (e.g., granulated or powdered particles of glass mixed with colored pigments) which may be fused onto or into the glass after printing.

FIGS. 15A and 15B show respective perspective views of an exploded assembly of a lighting assembly 600A including a transmissive 3D-printed body 610A and a panel lighting device 501A (e.g., SMD board 500A, a COB board 500C, etc.). As shown in FIG. 15A, transmissive 3D-printed body 610A may be generally cylindrical and include two recesses 612A, 614A. Recess 614A, as shown in FIGS. 15A and 15B, may be sized and configured for panel lighting device 501A to be positioned at least partially therein. Further, panel lighting device 501A may be attached to transmissive 3D-printed body 610A. For example, panel lighting device 501A and transmissive 3D-printed body 610A may be adhesively bonded (e.g., glued), welded, and/or attached to one another via one or more fastening element. Further, optionally, in some embodiments, a seal may be formed between panel lighting device 501A and transmissive 3D-printed body 610A to protect electrical connections to the panel lighting device 501A. In some embodiments, an adhesive may be disposed between transmissive 3D-printed body 610A and panel lighting device 501A. In some embodiments, a polyurethane-based adhesive may be used and/or a silicone-based adhesive may be used to attach or fasten transmissive 3D-printed body 610A to panel lighting device 501A. In some embodiments, adhesive may comprise 3M™ Marine Adhesive Sealant 5200 (fast cure or standard cure; commercially available from 3M). In some embodiments, a copolymer rubber-based sealant may be used to fasten body to the structural element. For example, in some embodiments, adhesive may comprise LEXEL® elastic sealants (commercially available from SASHCO). In some embodiments, optionally, an O-ring or other sealing element may be positioned between panel lighting device 501A and transmissive 3D-printed body 610A (e.g., to protect electrical connections to the panel lighting device 501A).

As shown in FIGS. 15A and 15B, recess 612A may be sized and configured for transmissive graphic element 616A and lens element 618A to be positioned at least partially therein. In some embodiments, as shown in FIGS. 15A and 15B, recess 612A may have a complementary peripheral shape relative to the peripheral shape of transmissive graphic element 616A and/or lens element 618A, respectively. Further, in some embodiments, as shown in FIGS. 15A and 15B, recess 614A may have a complementary peripheral shape relative to the peripheral shape of panel lighting device 501A. In some embodiments, transmissive graphic element 616A and/or lens element 618A may be round (e.g., disc shaped, cylindrical, ovoid, etc.). More generally, transmissive graphic element 616A and lens element 618A may have any selected shape, without limitation. In further detail, transmissive graphic element 616A may be configured such that at least some light emitted by the panel lighting device 501A passes through transmissive 3D-printed body 610A to illuminate transmissive graphic element 616A. Further, in at least one embodiment, transmissive graphic element 616A may be printed, formed, or adhered to lens element 618A or transmissive 3D-printed body 610A. In some embodiments, transmissive graphic element 616A may include a portion that is configured to block or dissipate light (e.g., opaque or substantially less transmissive than other portions of transmissive graphic element 616A) from panel lighting device 501A. In some embodiments at least one of the panel lighting device 501A and the transmissive 3D-printed body is sized and configured such that the infill of the 3D-printed article is visually discernable when the panel lighting device 501A is energized. As shown in FIGS. 15A and 15B, lighting assembly 600A may include power cord 630 which may be operably connected to an electrical plug 150, 150B, or 150C.

In another aspect of the present invention, a transmissive 3D-printed body may comprise attachment features to facilitate attaching a lighting assembly (e.g., 600A or 600B, as described below) to a smooth surface, such as a window. FIG. 15C shows a perspective view of a transmissive 3D-printed body 650 including three mounting features 624 defining recess/hole 625. For example, by positioning a suction cup within each recess/hole 625 of mounting feature 624, such mounting features 624 may be used to attach a lighting assembly to a surface (e.g., a window). In another embodiment, an adhesive may be positioned at least partially upon each mounting feature 624 such that a lighting assembly may be attached to a surface. In other embodiments, a fastening element may be positioned through each recess/hole 625 of each mounting feature 624 and each fastening element may engage or attach to (or into) a desired surface or feature to attach a lighting assembly to a surface or structure. In yet further embodiments, a fastening element may be positioned through each recess/hole 625 of each mounting feature 624 and each fastening element may engage or contact to (or into) a lens element (e.g., 618A, 618B, as described below, etc.) and/or a transmissive graphic element (e.g., 616A, 616B, as described below, etc.) to attach such lens element and/or transmissive graphic element to a transmissive 3D-printed body. Generally, one or more mounting feature 624 may be included by a transmissive 3D-printed body (e.g., 610A, 610B, as described below, etc.) and may be used for attachment of one or more components of a lighting assembly to one another and/or for attaching a transmissive 3D-printed body to a structure.

Optionally, as shown in FIGS. 15A and 15B, a structural element 43 may be included in lighting assembly 600A. As discussed herein (e.g., as described with respect to FIGS. 4A and 4B), structural element 43 may be configured for mounting into a vehicle hitch receiver. Structural element 43 may comprise any size suitable for mounting into a vehicle hitch receiver, without limitation. In other embodiments, as discussed herein, the structural element 43 shown in lighting assembly 600A (and 600B described below) may be omitted and lighting assembly 600A (and 600B described below) may be otherwise attached (e.g., by a different structural element, by an adhesive, by at least one fastener or fastening element, at least one suction cup, or by any other suitable attachment) to a vehicle, a house, a wall, a window, or any other structure. In some embodiments, lighting assembly 600A may include any element or feature (e.g., electrical driver, dimmer, attachment mechanism, etc.) as shown and/or described with respect to FIG. 12, without limitation. In some embodiments, lighting assembly 600A may be included in a system 300, as shown and/or described with respect to FIG. 12.

FIGS. 16A and 16B show respective perspective views of an exploded assembly of a lighting assembly 600B including a transmissive 3D-printed body 610B and a panel lighting device 501B (e.g., SMD board 500B, a COB board 500C, etc.). As shown in FIGS. 16A and 16B, transmissive 3D-printed body 610B may be generally cubic and include two recesses 612B, 614B. Recess 614B, as shown in FIGS. 16A and 16B, may be sized and configured for panel lighting device 501B to be positioned at least partially therein. Further, panel lighting device 501B may be attached to transmissive 3D-printed body 610B. For example, panel lighting device 501B and transmissive 3D-printed body 610B may be adhesively bonded (e.g., glued), welded, and/or attached to one another via one or more fastening element. Further, optionally, in some embodiments, a seal may be formed between panel lighting device 501B and transmissive 3D-printed body 610A. In some embodiments, an adhesive may be disposed between transmissive 3D-printed body 610B and panel lighting device 501B. In some embodiments, a polyurethane-based adhesive may be used and/or a silicone-based adhesive may be used to attach or fasten transmissive 3D-printed body 610B to panel lighting device 501B. In some embodiments, adhesive may comprise 3M™ Marine Adhesive Sealant 5200 (fast cure or standard cure; commercially available from 3M). In some embodiments, optionally, an O-ring or other sealing element may be positioned between panel lighting device 501B and transmissive 3D-printed body 610B (e.g., to protect electrical components/wiring).

Recess 612B, as shown in FIGS. 16A and 16B, may be sized and configured for transmissive graphic element 616B and lens element 618B to be positioned at least partially therein. In some embodiments, as shown in FIGS. 16A and 16B, recess 612B may have a complementary peripheral shape relative to the peripheral shape of transmissive graphic element 616B and/or lens element 618B, respectively. Further, in some embodiments, as shown in FIGS. 16A and 16B, recess 614B may have a complementary peripheral shape relative to the peripheral shape of panel lighting device 501B. In some embodiments, transmissive graphic element 616B and/or lens element 618B may be cubic (e.g., plate shaped, square, rectangular, etc.). More generally, transmissive graphic element 616B and lens element 618B may have any selected shape, without limitation. In further detail, transmissive graphic element 616B may be configured such that at least some light emitted by the panel lighting device 501B passes through transmissive 3D-printed body 610B to illuminate transmissive graphic element 616B. As shown in FIGS. 16A and 16B, lighting assembly 600B may include power cord 630 which may be operably connected to an electrical plug 150, 150B, or 150C.

Further, in at least one embodiment, transmissive graphic element 616B may be printed, formed, or adhered to lens element 618B or transmissive 3D-printed body 610B. In some embodiments, transmissive graphic element 616B may include a portion that is configured to block or dissipate light (e.g., opaque or substantially less transmissive than other portions of transmissive graphic element 616B) from panel lighting device 501B.

Optionally, a structural element (e.g., structural element 43 as shown in any FIGS. herein) may be included in lighting assembly 600B. In some embodiments, optionally, a structural element (not shown) may be included in lighting assembly 600B (as described with respect to FIGS. 15A and 15B). For example, as discussed herein (e.g., as described with respect to FIGS. 4A and 4B), a structural element may be configured for mounting into a vehicle hitch receiver. A Structural element may comprise any size suitable for mounting into a vehicle hitch receiver, without limitation. In other embodiments, as discussed herein, a structural element (e.g., structural element 43 shown in lighting assembly 600A) may be omitted and lighting assembly 600B may be otherwise attached (e.g., by a different structural element, by an adhesive, by at least one mounting feature, by at least one fastener or fastening element, at least one suction cup, or by any other suitable attachment) to a vehicle, a house, a wall, a window, or any other structure. In some embodiments, lighting assembly 600B may include any element or feature (e.g., electrical driver, dimmer, attachment mechanism, etc.) as shown and/or described with respect to FIG. 12, without limitation. In some embodiments, lighting assembly 600B may be included in a system 300, as shown and/or described with respect to FIG. 12.

In one embodiment, FIG. 16C shows an exploded assembly of a lighting assembly 599 including a transmissive 3D-printed body 610A, 610B, 650 and a panel lighting device 501A, 501B (e.g., SMD board 500A, SMD board 500B, COB board 500C, COB board 500D, etc.). As described hereinbefore, transmissive 3D-printed body 610A, 610B, 650 may include two recesses wherein one recess is sized and configured for a panel lighting device 501A, 501B to be positioned at least partially therein. Optionally, a panel lighting device 501A, 501B may be attached to transmissive 3D-printed body 610A, 610B, 650. For example, as described herein, panel lighting device 501A, 501B and transmissive 3D-printed body 610A, 610B, 650 may be adhesively bonded (e.g., glued), welded, and/or attached to one another via one or more fastening element. For example, in some embodiments, lens element 618A, 618B, transmissive graphic element 616A, 616B, transmissive 3D-printed body 610A, 610B, 650, and panel lighting device 501A, 501B may be held against one another with one or more clamp, clip, speed nut, speed clip, clipnut, U-nut, J-type speed nut, spring nut, U-type speed clip, ARaymond™ clip fastener, J-type spring nut, and/or clip nut. For example, such one or more fastening element may be commercially available from ARaymond North America LLC, A. Raymond Tinnerman Industrial, Inc., www.advancecomponents.com, and/or any of the foregoing company's affiliates or distributors. Further, optionally, in some embodiments, a seal may be formed between panel lighting device 501A, 501B and transmissive 3D-printed body 610A, 610B, 650. In some embodiments, as described herein, an adhesive may be disposed between transmissive 3D-printed body 610A, 610B, 650 and panel lighting device 501A, 501B. In some embodiments, optionally, an O-ring or other sealing element may be positioned between panel lighting device 501A, 501B and transmissive 3D-printed body 610A, 610B, 650 (e.g., to protect electrical connections/wiring).

As shown in FIG. 16C, a transmissive graphic element 616A, 616B and lens element 618A, 618B may be positioned adjacent to transmissive 3D-printed body 610A, 610B, 650 (e.g., within a recess formed by transmissive 3D-printed body 610A, 610B, 650). More generally, transmissive 3D-printed body 610A, 610B, 650 graphic transmissive element 616A, 616B, 650 and lens element 618A, 618B may have any selected shape, without limitation.

In some embodiments, transmissive graphic element 616A, 616B may be configured such that at least some light emitted by the panel lighting device 501A, 501B passes through transmissive 3D-printed body 610A, 610B, 650 to illuminate transmissive graphic element 616A, 616B. Further, in at least one embodiment, transmissive graphic element 616A, 616B may be printed, formed, or adhered to lens element 618A, 618B or transmissive 3D-printed body 610A, 610B, 650. In some embodiments, transmissive graphic element 616A, 616B may include a portion that is configured to block or dissipate light (e.g., opaque or substantially less transmissive than other portions of transmissive graphic element 616A, 616B) from panel lighting device 501A, 501B.

As shown in FIG. 16C, lighting assembly 599 includes power cord 630 which may be operably connected to an electrical plug 150, 150B, 150C. In some embodiments, lighting assembly 599 may include any element or feature (e.g., electrical driver, dimmer, attachment mechanism, etc.) as shown and/or described with respect to FIG. 12, without limitation. In some embodiments, lighting assembly 599 may be included in a system 300, as shown and/or described with respect to FIG. 12.

In some embodiments, one or more of lens element 618A, 618B and graphic transmissive element 616A, 616B, 650 may be omitted and a selected indicia (e.g., logo, graphic, image, letter, number, or other indicia) may be formed directly upon the transmissive 3D-printed body 610A, 610B, 650, the graphic transmissive element 616A, 616B, 650 and/or lens element 618A, 618B. For example, a selected indicia may be formed (e.g., printed, deposited, etc.) by ink-jet printing, laser printing, UV printing (e.g., using ultraviolet (UV) light to cure or dry UV ink that is applied to a substrate) or any suitable deposition process. UV printers may be commercially available from Mimaki, Mutoh, Epson, and Direct Color Systems, among others. If an indicia is formed directly upon the transmissive 3D-printed body 610A, 610B, 650, recess 612A may be omitted.

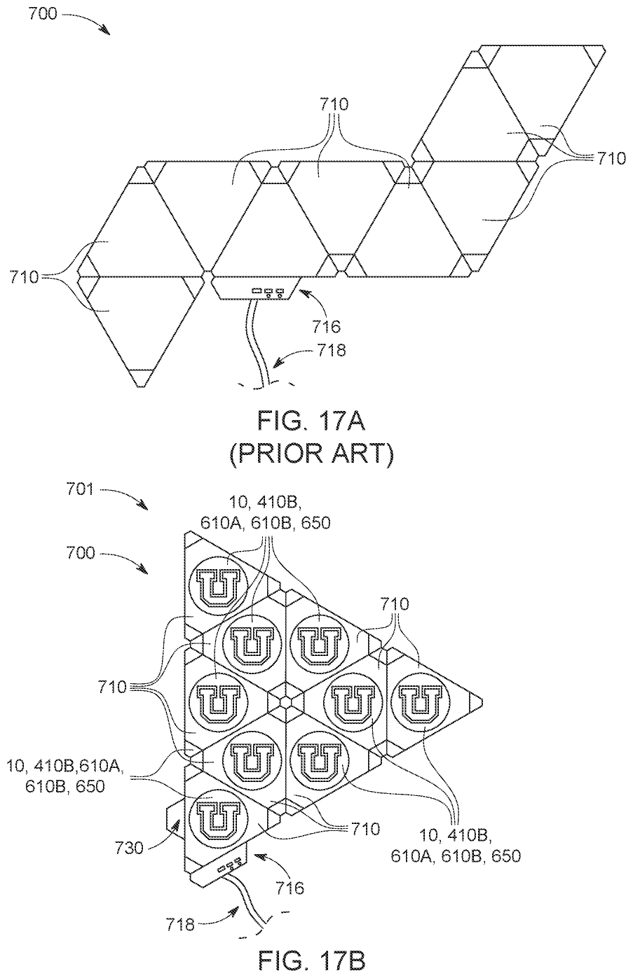

In yet another embodiment, a light panel system may comprise one or more light panel (e.g., a NANOLEAF® light panel). As shown in FIG. 17A, a light panel system 700 may comprise one or more light panels 710. In the case of a plurality of light panels 710, such light panels 710 may be electrically connected to one another by way of electrical connectors, as known in the art. Further, a controller module 716 may connect to any light panel 710 and may be configured to selectively control the brightness and/or color of each light panel 710 individually. As shown in FIG. 17A, power cord 718 may be operably coupled to controller module 716. Optionally, light panel system 700 may be further controlled by way of WIFI, Bluetooth, or other wireless communication.

Generally, at least one transmissive 3D-printed body may be sized, configured, and positioned such that light from a light panel system at least partially passes through the transmissive 3D-printed body. In some embodiments, any transmissive 3D-printed body (with or without a graphic element) disclosed herein may be backlit by at least one light panel of a light panel system. In more detail, as shown in FIG. 17B, lighting assembly 701 may comprise one or more transmissive 3D-printed body 10, 10B, 410B (e.g., excluding all features (e.g., 16, 18, 20, 24, 26, 28) other than grooves 12, 14), 610A (with or without lens element 618A), 610B (with or without lens element 618B), or 650, which may be releasably attached to at least one light panel 710 of light panel system 700. In some embodiments, a transmissive 3D-printed body 10, 410B, 610A, 610B, 650 may be attachable (to a light panel 710) and detachable (from a light panel 710) without the use of a tool (e.g., a screwdriver, a socket wrench, pliers, etc.). In some embodiments, at least one fastening element (e.g., a pin, a clip, such as an automotive clip, an expandable element, a suction cup, or any other suitable fastening element or fastener) may be used to releasably attach the transmissive 3D-printed body to a light panel 710. In one embodiment, the at least one fastening element may allow for the attachment and detachment of a transmissive 3D-printed body to and from light panel 710 without the use of a tool (e.g., a screwdriver, a socket wrench, pliers, etc.) In some embodiments, one or more magnet (e.g., one or more neodymium magnet) may be press-fit (e.g., into a recess formed by transmissive 3D-printed body), adhesively attached, or otherwise attached to transmissive 3D-printed body 10, 410B, 610A, 610B, 650. Further, a light panel 710 may comprise at least one magnetic material (e.g., a ferrous material, iron, nickel, cobalt, gadolinium, dysprosium, terbium, certain types of steel, neodymium). Accordingly, the magnet and magnetic material may be configured to allow for attachment and detachment of a transmissive 3D-printed body 10, 410B, 610A, 610B, 650 to and from light panel 710. Of course, in other embodiments, one or more magnet may be press-fit (e.g., into a recess formed by transmissive 3D-printed body), adhesively attached, or otherwise attached to a light panel and a transmissive 3D-printed body 10, 410B, 610A, 610B, 650 may comprise at least one magnetic material. Optionally, in some embodiments, more than one transmissive 3D-printed body 10, 410B, 610A, 610B, 650 may be configured to be attached (i.e., one at a time or more than one at a time) and/or removed relative to one or more light panel. Such a configuration may allow for selective customization of an assembly comprising a transmissive 3D-printed body 10, 410B, 610A, 610B, 650 and a panel lighting assembly 700.

In some embodiments, such as a transmissive 3D-printed body 10, 410B, 610A, 610B, 650, an indicia formed by the structure of the transmissive 3D-printed body may be visually discernable by way of light at least partially passing through the transmissive 3D-printed body. In some embodiments, a transmissive 3D-printed body and a graphic element may be used in combination with one another to visually convey an indicia. In any embodiment, optionally, the infill of a transmissive 3D-printed article may be visually discernable when a panel lighting device 710 to which the transmissive 3D-printed article is attached emits light (i.e., is energized).

While various aspects and embodiments have been disclosed herein, other aspects and embodiments are contemplated. The various aspects and embodiments disclosed herein are for purposes of illustration and are not intended to be limiting. Accordingly, other embodiments may be within the scope of the following claims. Unless otherwise noted, the terms “a” or “an,” as used in the specification and claims, are to be construed as meaning “at least one of. Additionally, the words “including,” “having,” and variants thereof (e.g., includes, include, have, and has) as used herein, including the claims, shall be open-ended and have the same meaning as the word “comprising” and variants thereof (e.g., “comprise” and “comprises”).

What is claimed is:

1. A lighting assembly, comprising:
a transmissive 3D-printed body comprising infill;
a panel lighting device attached to the transmissive 3D-printed body;
a transmissive graphic element;
wherein at least one of the panel lighting device and the transmissive 3D-printed body is sized and configured such that the infill of the transmissive 3D-printed body is visually discernable when the panel lighting device is energized.

2. The lighting assembly according to claim 1, wherein the panel lighting device has a surface over which a plurality of LEDs are spaced and an area of the surface has a size between 12 square inches and 52 square inches.

3. The lighting assembly according to claim 1, further comprising a lens element attached to the transmissive 3D-printed body.

4. The lighting assembly according to claim 1, further comprising a structural element attached to the panel lighting device.

5. The lighting assembly according to claim 4, wherein the structural element is sized and configured for mounting into a vehicle hitch receiver.

6. The lighting assembly according to claim 2, further comprising a dimmer device.

7. The lighting assembly according to claim 6, wherein the dimmer device comprises an adjustable current dimmer or a PWM dimmer.

8. The lighting assembly according to claim 7, wherein the volume percentage of the infill is less than 50%.

9. The lighting assembly according to claim 3, wherein the transmissive graphic element is formed upon the lens element.

10. The lighting assembly according to claim 2, wherein the panel lighting device is a COB LED comprising a phosphor coating area having a size between 12 square inches and 52 square inches.

11. The lighting assembly according to claim 6, wherein the panel lighting device is configured to emit more than one color of light.

12. The lighting assembly according to claim 7, wherein the panel lighting device has a maximum wattage of between 10 watts and 30 watts and the dimmer device is configured to limit the panel lighting device to between 5% and 50% of its maximum wattage.

13. A lighting assembly, comprising:
a light panel system comprising a plurality of light panels;
a transmissive 3D-printed body comprising infill;
wherein the transmissive 3D-printed body is configured to be attachable to a selected light panel of the plurality of light panels and detachable from the selected light panel without the use of a tool;
wherein at least one of the selected light panel and the transmissive 3D-printed body is sized and configured such that the infill of the transmissive 3D-printed body is visually discernable when the panel lighting device is energized.

14. The lighting assembly according to claim 13, further comprising at least one fastening element for attaching the transmissive 3D-printed body to the selected light panel.

15. The lighting assembly according to claim 14, wherein the at least one fastening element comprises a magnet or a magnetic material.

16. The lighting assembly according to claim 13, wherein the selected light panel is configured to emit more than one color of light.

17. The lighting assembly according to claim 13, wherein the volume percentage of the infill is less than 50%.

18. The lighting assembly according to claim 13, wherein the light panel system is controllable by way of at least one of WIFI and Bluetooth.

19. The lighting assembly according to claim 13, further comprising a transmissive graphic element.
